(19) United States
(12) Patent Application Publication
(10) Pub. No.: US 2026/0366090 A1
(43) Pub. Date: Nov. 19, 2026

(54) SURFACE-TREATED, WATER-RESISTANT SILK LEATHER

(71) Applicants: Trustees of Tufts College, MEDFORD, MA (US); Canon Virginia, Inc., Newport News, VA (US)

(72) Inventors: Fiorenzo G. Omenetto, Lexington, MA (US); Marco Lo Presti, Arlington, MA (US); Syed Muhammad Husainie, Etobicoke (CA); Harsha D. Magurudeniya, Newport News, VA (US)

(21) Appl. No.: 19/681,637

(22) Filed: May 19, 2026

Related U.S. Application Data
(60) Provisional application No. 63/808,348, filed on May 19, 2025.

(51) Int. Cl. C14C 11/00; D06N 3/00

(52) U.S. Cl. CPC C14C 11/00; D06N 3/0015; D10B 2211/04; D10B 2401/02

(57) ABSTRACT

An ionic-treated silk leather may have at least a portion of at least one surface treated with an ionic surface treatment comprising water, a cation, and optionally a carrier solvent. A method of treating silk leather may comprise applying an ionic surface treatment to an untreated silk leather to form an ionic-treated silk leather. A method of inducing thermal transition in a gelatin-containing silk leather may include applying an elevated pressure for a pressure applying length of time and an elevated temperature for a temperature applying length of time to the silk leather to form a thermal transition silk leather. A method of inducing patterned thermal transition in a gelatin-containing silk leather may include applying an elevated pressure for a pressure applying length of time and an elevated temperature for a temperature applying length of time using a patterned stamp.

### CROSS-REFERENCE TO RELATED APPLICATION

This application relates to, incorporates by reference for all purposes, and claims priority to U.S. Provisional Application Ser. No. 63/808,348 (Attorney Docket No. 2095.0661), filed May 19, 2025.

### BACKGROUND

Sustainability in materials is an area of increasing interest. One material that is sustainable in a certain sense is leather, in that it can be reproduced and grown from animals. However, this material is not sustainable when it comes to humane treatment of animals. Alternatives to leather have been pursued for decades, but those alternatives have primarily been non-sustainable alternatives.

A need exists for alternatives to conventional leather as a material for use across the spectrum of applications where conventional leather is used.

### SUMMARY

In some aspects, the techniques described herein relate to an ionic-treated silk leather with improved water resistance, the ionic-treated silk leather having at least a portion of at least one surface treated with an ionic surface treatment, wherein the ionic surface treatment includes: water, a cation, and optionally a carrier solvent.

In some aspects, the techniques described herein relate to a method of treating silk leather with an ionic compound, the method including applying an ionic surface treatment to an untreated silk leather to form an ionic-treated silk leather, wherein the ionic surface treatment includes: water, a cation, and optionally a carrier solvent.

In some aspects, the techniques described herein relate to a method of inducing thermal transition in a silk leather, the method including applying an elevated pressure for a pressure applying length of time and an elevated temperature for a temperature applying length of time to the silk leather to form a thermal transition silk leather, wherein the thermal transition silk leather has a degree of transition, wherein the silk leather includes gelatin.

In some aspects, the techniques described herein relate to a silk leather that is a layered structure including a first thermal transition silk leather layer and a second material layer disposed adjacent to the first thermal transition silk leather layer, wherein the first thermal transition silk leather layer has been treated with a thermal transition treatment.

In some aspects, the techniques described herein relate to a silk leather that is a layered structure including a first thermal transition silk leather layer and a second material layer disposed adjacent to the first thermal transition silk leather layer, wherein an adhesion strength as measured by a T-Peel test between the first thermal transition layer and the second material layer is at least 15 Newtons/meter (N/m), at least 17 N/m, at least 20 N/m, at least 22 N/m, at least 25 N/m, at least 30 N/m, at least 40 N/m, at least 50 N/m, at least 60 N/m, or at least 70 N/m.

In some aspects, the techniques described herein relate to a method of inducing patterned thermal transition in a silk leather, the method including applying an elevated pressure for a pressure applying length of time and an elevated temperature for a temperature applying length of time to the silk leather using a patterned stamp to form a patterned thermal transition silk leather, wherein the thermal transition silk leather has a degree of transition, wherein the silk leather includes gelatin.

### BRIEF DESCRIPTION OF THE FIGURES

The disclosure and the following detailed description of certain aspects thereof may be understood by reference to the following figures:

FIG. 1A-FIG. 1D depict coatings with Ajisawa solutions. FIG. 1A) Photographs of leathers after dipping in the solution and FIG. 1B) cross section detail of CuCl₂ dipping and treatment penetration. FIG. 1C) mass loss of the coated leather after water immersion and drying. FIG. 1D) appearance (top) and cross-section (bottom) of CuCl₂ coatings at higher concentrations or longer dipping time.

FIG. 2 depicts alginate (left) and xanthan gum (right) based leathers after thermal pressing between 10 and 30 minutes.

FIG. 3A) Gelatin-based leather samples after thermal pressing for 10 to 30 minutes, showing progressive transition and uniformity. FIG. 3B) Alginate-based leather and FIG. 3C) gelatin-based leather after 30 minutes of thermal compression at 120 °C and 10 MPa between plastic canvas layers, highlighting the difference in thermal degradation and uniformity of transition.

FIG. 4 depicts thermal compression at 120 °C and 10 MPa, for 20 minutes for a composition combining Alg and XG (left), Alg with different glycerol content (center) and gelatin (right) with or without an organza silk textile in between.

FIG. 5A-FIG. 5H depict material properties imparted by the thermal transition process. FIG. 5A) two different fabrics compressed to make a patterned structure; FIG. 5B) a cross section of the fabric from FIG. 5A); FIG. 5C) and FIG. 5D) are various patterns and geometries; FIG. 5E) creation of custom patterns using embossing grids; FIG. 5F) square regions of the fabric from FIG. 5A); FIG. 5G) and FIG. 5H) show transparent materials surrounding areas that remain opaque.

FIG. 6 depicts cream density as a function of whipping time alg, XG or gelatin (20%) composition with SF (20%) and glycerol (60%).

FIG. 7A-FIG. 7E depict thermal transition and water stability of silk/alg and silk/gel leathers. FIG. 7A) photographs of KIMICA alginates samples hot pressed at 120 °C and 10 MPa for 30 minutes. FIG. 7B) photographs before and FIG. 7C) after 8 hours of water immersion. FIG. 7D) ultimate tensile strength and FIG. 7E) ultimate strain of KIMICA alginates and gelatin-based leathers.

FIG. 8A-FIG. 8D depicts thermal transition of silk leathers. Thermopressing at 120 °C, 10 MPa within a squared plastic canvas of FIG. 8A) SF₂₀:Alg₂₀:Gly₆₀ and FIG. 8B) SF₂₀:Gel₂₀:Gly₆₀ leather compositions. FIG. 8C) cream densities comparison against Wt for Alg, XG and Gel. FIG. 8D) composites materials obtained by pressing SF₂₀:Gel₂₀:Gly₆₀ foams on textiles.

FIG. 9A depicts a flowchart of silk leather sample treatment.

FIG. 9B depicts a schematic of silk leather sample treatment.

FIG. 10 depicts water absorption of various leathers and surface-treated leathers.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

### DEFINITIONS

As used herein, “low molecular weight” silk fibroin refers to silk fibroin that has been subjected to boiling during degumming or another processing step for a length of time of at least 30 minutes, thereby reducing the average molecular weight of the protein fragments. Examples of low molecular weight silk fibroin can be found at WO 2014/145002, which is incorporated herein in its entirety by reference.

As used herein, mysilkium refers to a material that is composed of at least 20% silk fibroin and which has one or more material properties (e.g., compressive modulus, tensile strength, etc.) falling within 50%, within 25%, within 20%, within 15%, or within 10% of a native mycelium.

As used herein, “silk fibroin” refers to silk fibroin protein whether produced by silkworm, spider, or other insect, or otherwise generated (Lucas et al., Adv. Protein Chem., 13: 107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein by reference in their entireties.

The thermal fusion process relies on molecular rearrangement and self-assembly, assisted by bound water, to create a robust, transparent, and water-resistant bulk material. This disclosure focuses on monomaterials composed exclusively of silk, typically starting from lyophilized powders that, through thermal processing, form an extended β-sheet network throughout the bulk.

While these materials are of broad interest due to their biocompatibility, aesthetic quality, and mechanical properties, their processability is limited. The thermoplastic window is narrow, enabling only the fusion of powders into a bulk material, which must then be shaped via mechanical machining. Further thermal or laser processing often leads to burning, as the glass transition temperature of silk fibroin is very close to its degradation temperature.

Although previous efforts have explored the use of additives to plasticize silk and enhance its processability, the methodology—based on pressing dry lyophilized powders—is generally incompatible with liquid plasticizers (e.g., glycerol). Additionally, incorporating other solid-state additives often interferes with bulk formation or leads to poor material homogeneity.

In contrast, processing silk initially in the form of a foam allows for the incorporation of various water-soluble molecules, enabling homogeneous blending of additives such as polysaccharides and plasticizers. This approach may overcome some of the limitations observed in pure silk thermoplastic processing. The present disclosure aims to evaluate whether the thermoplastic molding process can be effectively extended to silk-based foams containing additives like polysaccharides and glycerol.

### Liquid Compositions

The present disclosure provides a liquid composition. Compositions disclosed herein may include a protein, at least one polysaccharide, and a plasticizer. In embodiments, the protein may be silk fibroin. In embodiments, the polysaccharide may be xanthan gum, an alginate, or another high molecular weight sugar, cellulose derivative (e.g., microcrystalline cellulose, hydroxypropyl cellulose, carboxymethyl cellulose), combinations thereof, or the like. In embodiments, the polysaccharide may be a thickening agent. In embodiments, the polysaccharide may be carrageenan. Liquid compositions containing xanthan gum may be superior at obtaining silk leathers. It should be understood, however, that examples and embodiments throughout this Specification that reference xanthan gum as a component may comprise a different polysaccharide in place of, or in addition to, xanthan gum, such as an alginate. In some embodiments, selection of the particular polysaccharide or combination of polysaccharides used in the liquid composition may depend on the ultimate material properties desired. For example, in some aspects, alginate may be preferred if a free-standing leather material is desired. It is expressly contemplated that certain applications may require a combination of different polysaccharides within the same composition, such as a specific application requiring a whipped silk cream including silk fibroin, glycerol, xanthan gum, and alginate as the principal components.

In some aspects, the weight ratio of silk fibroin, polysaccharide, and plasticizer may have an impact on one or more of a mechanical property, a density, or a water content of a resulting material made from the composition. Without wishing to be bound by any particular theory, variations of the weight of the plasticizer may preferentially impact mechanical properties, variations of the weight of the polysaccharide or combination of polysaccharides may preferentially impact density, and variations of the weight of the silk fibroin may preferentially impact water content.

In some embodiments, the liquid composition includes a mixture of silk fibroin and xanthan gum. In some aspects, the liquid composition includes a mixture of silk fibroin, xanthan gum, and a plasticizer. In some aspects, the liquid composition includes a mixture of silk fibroin, xanthan gum, and glycerol. In some aspects, the liquid composition includes a mixture of silk fibroin, xanthan gum, and a functionalizing agent. In some aspects, the liquid composition includes a mixture of silk fibroin, xanthan gum, a plasticizer, and a functionalizing agent. In some aspects, the liquid composition includes a mixture of silk fibroin, xanthan gum, glycerol, and a functionalizing agent. In some aspects, the liquid composition includes a mixture of silk fibroin and a high molecular weight sugar (e.g., such as xanthan gum), and may optionally further include at least one of a plasticizer (e.g., such as glycerol) or a functionalizing agent.

The liquid composition can include other components that a skilled artisan will recognize are valuable in certain contexts. In certain cases, the liquid composition can further include glycerol. In certain cases, the liquid composition can further include a sensing agent. In certain case, the liquid composition can further include a therapeutically active agent. In certain cases, the liquid composition can include an aroma-providing compound.

The mixture of silk fibroin and polysaccharide (e.g., xanthan gum, alginate, etc.) includes a weight ratio of silk fibroin to polysaccharide of between 1:4 and 20:1 or between 1:2 and 10:1. For example, the mixture of silk fibroin and polysaccharide can include a weight ratio of silk fibroin to polysaccharide of at least 1:4, at least 1:3, or at least 1:2. For example, mixture of silk fibroin and polysaccharide can include a weight ratio of silk fibroin to polysaccharide of at most 20:1, at most 19:1, at most 18:1, at most 16:1, at most 15:1, at most 14:1, at most 12:1, at most 11:1, or at most 10:1.

The silk fibroin can be present in the liquid composition in an amount by weight of between 1% and 10% or between 3% and 7%. Without wishing to be bound by any particular theory, it is believed that the concentration of silk fibroin can impact the structural integrity of a resulting product. If the concentration is too low, the resulting product may not coalesce into a single physical structure, thereby failing to make an article at all. If the concentration is too high, the resulting product may form in a fashion with visible defects, cracks, and other imperfections. For example, the silk fibroin can be present in the liquid composition in an amount by weight of at least 1%, at least 2%, at least 3%, at least 4%, at least 5%, or at least 6%. For example, the silk fibroin can be present in the liquid composition in an amount by weight of at most 10%, at most 9%, at most 8%, at most 7%, at most 6%, or at most 5%.

The polysaccharide can be present in the liquid composition in an amount by weight of between 0.1% and 10.0%. For example, the polysaccharide can be present in the liquid composition in an amount by weight of at least 0.1%, at least 0.3%, at least 0.5%, at least 1.0%, at least 1.5%, at least 2.0%, at least 2.5%, at least 3.0%, at least 3.5%, at least 4.0%, at least 4.5%, at least 5.0%, at least 5.5%, at least 6.0%, at least 6.5%, at least 7.0%, at least 7.5%, at least 8.0%, at least 8.5%, at least 9.0%, or at least 9.5%. For example, the polysaccharide can be present in the liquid composition in an amount by weight of at most 10.0%, at most 9.5%, at most 9.0%, at most 8.5%, at most 8.0%, at most 7.5%, at most 7.0%, at most 6.5%, at most 6.0%, at most 5.5%, at most 5.0%, at most 4.5%, at most 4.0%, at most 3.5%, at most 3.0%, at most 2.5%, at most 2.0%, at most 1.5%, or at most 1.0%.

The plasticizer can be present in the liquid composition in an amount by weight of between 0.5% and 20.0%. For example, the plasticizer can be present in the liquid composition in an amount by weight of at least 0.5%, at least 1.0%, at least 1.5%, at least 2.0%, at least 2.5%, at least 3.0%, at least 3.5%, at least 4.0%, at least 4.5%, at least 5.0%, at least 5.5%, at least 6.0%, at least 6.5%, at least 7.0%, at least 7.5%, at least 8.0%, at least 8.5%, at least 9.0%, at least 9.5%, at least 10.0%, at least 12.0%, or at least 15.0%. For example, the plasticizer can be present in the liquid composition in an amount by weight of at most 20.0%, at most 18.5%, at most 17.5%, at most 16.0%, at most 15.0%, at most 14.0%, at most 13.0%, at most 12.5%, at most 11.0%, at most 10.0%, at most 8.0%, or at most 5.0%.

The plasticizer can be present in the liquid composition in an amount by weight of between 20.0% and 75.0%. For example, the plasticizer can be present in the liquid composition in an amount by weight of at least 20.0%, at least 25.0%, at least 30.0%, at least 35.0%, at least 40.0%, at least 45.0%, at least 50.0%, at least 55.0%, at least 60.0%, at least 65.0%, or at least 70.0%. For example, the plasticizer can be present in the liquid composition in an amount by weight of at most 75.0%, at most 70.0%, at most 65.0%, at most 60.0%, at most 55.0%, at most 50.0%, at most 45.0%, at most 40.0%, at most 35.0%, at most 30.0%, at most 25.0%, or at most 20.0%.

Plasticizers can include at least one of polyols, esters, phthalates, terephthalates, trimellitates, adipates, sebacates, organophosphates, ethanolamines, waxes, resins, or glycerols. The plasticizer can be selected from the group consisting of glycerol, 1,2 pentanediol, 1,5 pentanediol, 1,2,6 hexanetriol, and mixtures thereof. In some cases, the plasticizer is glycerol. In some cases, the plasticizer is 1,2 pentanediol. In some cases, the plasticizer is 1,5 pentanediol. In some cases, the plasticizer is 1,2,6 hexanetriol. In some cases, the plasticizer is at least one of xylitol, alditol, 1,2-pentanediol, 1,5-pentanediol, 1,2,6-hexanetriol, oleoyl-glycerol, cottonseed oil, di(ethylene glycol), tri(ethylene glycol), di(propylene glycol), tri(propylene glycol), or a vegetable oil.

Without wishing to be bound by any particular theory, it is believed that the number or and/or separation between —OH substituents can strongly impact the material properties of the resulting composition. In some cases, the plasticizer comprises at least one —OH substituent. In some cases, the plasticizer comprises at least two —OH substituents, at least 3 —OH substituents, or more —OH substituents. In some cases, the at least two —OH substituents, the at least 3 —OH substituents, or the more —OH substituents are separated from one another on the plasticizer by at least 2 carbon atoms, at least 3 carbon atoms, or at least 4 carbon atoms.

In some cases, the plasticizer can be partly or wholly evaporated off during processing. In some cases, the plasticizer remains within the composition during processing.

The sensing agent can be present in an amount that is selected by the nature of the sensing agent and the nature of the desired sensing performance. Similarly, a therapeutically active agent can be present in an amount that is selected by the nature of the therapeutically active agent and the nature of the desired therapeutic outcome. Similarly, a colorant can be present in an amount that is selected by the nature of the coloring ability of the colorant and the nature of the desired coloring. Similarly, an aroma-providing compound can be present in an amount that is selected by the nature of the aroma-providing ability of the compound and the nature of the desired aroma performance. A skilled artisan will recognize that there will be differing lower and upper boundaries for the amount of sensing agent, therapeutically active agent, colorant, and/or aroma-providing compound that will be present based on the nature of the agent. The aforementioned additives, agents, colorants, etc. can optionally be food-safe versions, which are identified as generally recognized as safe according to the US Food and Drug Administration. The additive can be inorganic, with uses such as fluorescent materials, lasing materials/media, absorbing/light responsive materials, temperature-sensitive materials, electrochemical materials, or combinations thereof.

In some aspects of the liquid composition or any of the downstream products or articles of manufacture disclosed herein, between 3% and 72% of the total weight of the silk fibroin, the polysaccharide, and the plasticizer is the silk fibroin. In some aspects of the liquid composition or any of the downstream products or articles of manufacture disclosed herein, between 3% and 72% of the total weight of the silk fibroin, the polysaccharide, and the plasticizer is the polysaccharide. In an example, the polysaccharide is present in an amount by weight of between 10% and 32% of the total weight of the silk fibroin, the polysaccharide, and the plasticizer, wherein the polysaccharide is optionally an alginate. In some aspects of the liquid composition or any of the downstream products or articles of manufacture disclosed herein, between 25% and 94% of the total weight of the silk fibroin, the polysaccharide, and the plasticizer is the plasticizer. In some examples, the plasticizer is present in an amount by weight of between 5% and 80% of the total weight of the silk fibroin, the polysaccharide, and the plasticizer. In some aspects of the liquid composition or any of the downstream products or articles of manufacture disclosed herein, between 3% and 72% of the total weight of the silk fibroin, the polysaccharide, and the plasticizer is the polysaccharide, and between 25% and 94% of the total weight of the silk fibroin, the polysaccharide, and the plasticizer is the plasticizer.

In some aspects of the liquid composition or any of the downstream products or articles of manufacture disclosed herein, between 15% and 25% of the total weight of the silk fibroin, the polysaccharide, and the plasticizer is the silk fibroin, between 50% and 70% of the total weight of the silk fibroin, the polysaccharide, and the plasticizer is the plasticizer, and between 15% and 25% of the total weight of the silk fibroin, the polysaccharide, and the plasticizer is the polysaccharide.

In some aspects of the liquid composition or any of the downstream products or articles of manufacture disclosed herein, between 15% and 25% of the total weight of the silk fibroin and the plasticizer is the silk fibroin, and between 75% and 85% of the total weight of the silk fibroin and the plasticizer is the plasticizer.

In some aspects of the liquid composition or any of the downstream products or articles of manufacture disclosed herein, between 30% and 35% of the total weight of the silk fibroin, the polysaccharide, and the plasticizer is the silk fibroin, between 30% and 35% of the total weight of the silk fibroin, the polysaccharide, and the plasticizer is the plasticizer, and between 30% and 35% of the total weight of the silk fibroin, the polysaccharide, and the plasticizer is the polysaccharide.

In some aspects of the liquid composition or any of the downstream products or articles of manufacture disclosed herein, between 35% and 45% of the total weight of the silk fibroin, the polysaccharide, and the plasticizer is the silk fibroin, between 15% and 25% of the total weight of the silk fibroin, the polysaccharide, and the plasticizer is the plasticizer, and between 35% and 45% of the total weight of the silk fibroin, the polysaccharide, and the plasticizer is the polysaccharide.

In some aspects of the liquid composition or any of the downstream products or articles of manufacture disclosed herein, between 15% and 25% of the total weight of the silk fibroin, the polysaccharide, and the plasticizer is the silk fibroin, between 35% and 45% of the total weight of the silk fibroin, the polysaccharide, and the plasticizer is the plasticizer, and between 35% and 45% of the total weight of the silk fibroin, the polysaccharide, and the plasticizer is the polysaccharide.

In some aspects of the liquid composition or any of the downstream products or articles of manufacture disclosed herein, between 35% and 45% of the total weight of the silk fibroin, the polysaccharide, and the plasticizer is the silk fibroin, between 35% and 45% of the total weight of the silk fibroin, the polysaccharide, and the plasticizer is the plasticizer, and between 15% and 25% of the total weight of the silk fibroin, the polysaccharide, and the plasticizer is the polysaccharide.

In some aspects of the liquid composition or any of the downstream products or articles of manufacture disclosed herein, between 45% and 85% of the total weight of the silk fibroin and the polysaccharide is the silk fibroin, and between 15% and 55% of the total weight of the silk fibroin and the polysaccharide is the polysaccharide.

In some aspects of the liquid composition or any of the downstream products or articles of manufacture disclosed herein, between 45% and 55% of the total weight of the silk fibroin and the polysaccharide is the silk fibroin, and between 45% and 55% of the total weight of the silk fibroin and the polysaccharide is the polysaccharide.

In some aspects of the liquid composition or any of the downstream products or articles of manufacture disclosed herein, between 55% and 65% of the total weight of the silk fibroin and the polysaccharide is the silk fibroin, and between 35% and 45% of the total weight of the silk fibroin and the polysaccharide is the polysaccharide.

In some aspects of the liquid composition or any of the downstream products or articles of manufacture disclosed herein, between 65% and 75% of the total weight of the silk fibroin and the polysaccharide is the silk fibroin, and between 25% and 35% of the total weight of the silk fibroin and the polysaccharide is the polysaccharide.

In some aspects of the liquid composition or any of the downstream products or articles of manufacture disclosed herein, between 15% and 25% of the total weight of the silk fibroin, the polysaccharide, and the plasticizer is the silk fibroin, between 15% and 25% of the total weight of the silk fibroin, the polysaccharide, and the plasticizer is the plasticizer, and between 55% and 65% of the total weight of the silk fibroin, the polysaccharide, and the plasticizer is the polysaccharide.

The liquid composition has a high water content. In some cases, the liquid composition has a water content of between 89% and 99%.

In some aspects, the liquid composition or any of the downstream products or articles of manufacture disclosed herein may further include multi-valent metal ions, such as calcium or copper. Where the polysaccharide is an alginate, the multi-valent metal ions may be present in a concentration of at least 10 mmol of the multi-valent metal ion per gram of the alginate and at most 250 mmol of the multi-valent metal ion per gram of the alginate, including but not limited to, at least 20 mmol, at least 30 mmol, at least 40 mmol, or at least 50 mmol, and at most 240 mmol, at most 225 mmol, at most 210 mmol, at most 200 mmol, at most 175 mmol, or at most 150 mmol. In some cases, the multi-valent metal ions are introduced in the form of CuCl₂. In some cases, the multi-valent metal ions are introduced in the form of CaCO₃, which can reduce yellowing in downstream compositions.

In some aspects, the liquid composition or any of the downstream products or articles of manufacture disclosed herein may further include a salt, such as a chloride salt. The salt may be present in a concentration of at least 10 mmol per gram of non-water component (e.g., all non-water ingredients—non-water component can be replaced with a dry solids basis, as would be appreciated by a skilled artisan, if other solvents are used) and at most 500 mmol per gram of non-water component, including but not limited to, at least 25 mmol, at least 50 mmol, or at least 100 mmol, and at most 450 mmol, at most 400 mmol, at most 300 mmol, or at most 250 mmol.

In some aspects, the liquid composition or any of the downstream products or articles of manufacture disclosed herein may further include shellac, such as in an amount by weight of between 0.1% and 50%.

In some aspects, the liquid composition or any of the downstream products or articles of manufacture disclosed herein may further include a natural wax, such as in an amount by weight of between 0.1% and 50.

In some aspects, the liquid composition or any of the downstream products or articles of manufacture disclosed herein may further include lycopodium powder, such as in an amount by weight of between 0.1% and 50%.

In some aspects, the liquid composition or any of the downstream products or articles of manufacture disclosed herein may further include at least one of a conductive additive, a non-conductive additive, or a thermally-conductive additive (e.g., electrically insulating).

### Whipped Silk Creams

Much like dairy milk can be whipped into a cream because of the emulsion-forming capacity of its high fat content, unexpectedly, silk fibroin solutions can be whipped up to a foam in the presence of high molecular weight sugars, such as xanthan gum or alginates. Foams obtained this way may be brittle and may display higher wettability towards organic solvents. Adding plasticizers to the composition may remove the brittleness and makes the foams more hydrophilic and encourages sponge-like behavior in water environments.

The present disclosure provides a whipped silk cream comprising silk fibroin and xanthan gum. In some aspects, the whipped silk cream comprises silk fibroin, xanthan gum, and a plasticizer. In some aspects, the whipped silk cream comprises silk fibroin, xanthan gum, and glycerol. In some aspects, the whipped silk cream comprises silk fibroin, xanthan gum, a plasticizer, and a functionalizing agent. In some aspects, the whipped silk cream comprises silk fibroin, xanthan gum, glycerol, and a functionalizing agent. In some aspects, the whipped silk cream comprises silk fibroin, xanthan gum, and a functionalizing agent. In some aspects, the whipped silk cream comprises a mixture of silk fibroin and a high molecular weight sugar (e.g., such as xanthan gum), and may optionally further include at least one of a plasticizer (e.g., such as glycerol) or a functionalizing agent.

Compositionally, the whipped silk cream can contain the same components in the same amounts as the liquid composition, with the liquid composition being transformed by the whipping process into a whipped silk cream.

The whipped silk cream can have an irregular porosity.

In some cases, the whipped silk cream can have an overrun that is comparable to the overrun of dairy whipped cream. Certain properties of the whipped silk cream may be associated with particular overrun values. In some aspects, the properties of the whipped silk cream at a particular overrun value may be variable based on if the particular overrun value is achieved before or after achieving a maximum overrun value. Maximum overrun values may depend on at least one of: the components included in the liquid composition, the weight ratio of one or more components in the liquid composition, the weight % of one or more components in the liquid composition, the amount of whipping time, or the temperature during whipping. In one example, liquid compositions including plasticizers may exhibit greater overrun relative to compositions lacking or having reduced amounts of plasticizers.

The whipped silk cream may exhibit an overrun of between 10% and 550%, between 20% and 550%, between 50% and 300%, between 10% and 100%, between 10% and 150%, between 10% and 300%, or between 100% and 300%. The whipped silk cream may exhibit an overrun of at least 10%, at least 50%, at least 100%, at least 200%, at least 300%, at least 400%, or at least 500%.

Given that the whipped silk cream is a downstream product from the liquid composition, the whipped silk cream can include any component or feature of the liquid composition, unless the context clearly dictates otherwise (e.g., if the feature relates specifically to being a liquid and not whipped).

The whipped silk cream has a water content that can be tailored for specific uses. In some cases, the water content of the whipped silk cream is between 50% and 95%, including but not limited to, between 75% and 93%, between 87% and 92%, or between 88.5% and 91%, including non-recited combinations of the upper and lower limits of those ranges (e.g., between 88.5% and 95%, etc.).

### Silk Meringue

The present disclosure provides a silk meringue comprising silk fibroin and xanthan gum. In some aspects, the silk meringue comprises silk fibroin, xanthan gum, and a plasticizer. In some aspects, the silk meringue comprises silk fibroin, xanthan gum, and glycerol. In some aspects, the silk meringue comprises silk fibroin, xanthan gum, a plasticizer, and a functionalizing agent. In some aspects, the silk meringue comprises silk fibroin, xanthan gum, glycerol, and a functionalizing agent. In some aspects, the silk meringue comprises silk fibroin, xanthan gum, and a functionalizing agent. In some aspects, the silk meringue comprises a mixture of silk fibroin and a high molecular weight sugar (e.g., such as xanthan gum), and may optionally further include at least one of a plasticizer (e.g., such as glycerol) or a functionalizing agent.

The silk meringue is a baked whipped silk cream. The silk meringue may be alternatively described as a foam herein. Compositionally, the silk meringue can contain the same components in the same amounts as the liquid composition and the whipped silk cream, with significantly less water/moisture content. Without wishing to be bound by any particular theory, it is believed that the whipping process and baking process can both give distinct characteristics to the silk meringue disclosed herein, with unique pore structure and size being generated by varying compositional and/or processing parameters.

Given that the silk meringue is a downstream product from the whipped silk cream, the silk meringue can include any component or feature of the whipped silk cream, unless the context clearly dictates otherwise (e.g., the water content is much lower in silk meringues). Similarly, as both the silk meringue and the whipped silk cream derive from the liquid composition, the silk meringue can include any component or feature of the liquid composition, unless the context clearly dictates otherwise.

The silk meringue has a water content that can be tailored for specific uses. The silk meringue can have a water content of between 5% and 70%. In some cases, the silk meringue has a water content of at least 5%, at least 10%, at least 15%, at least 20%, at least 25%, or at least 50%. In some cases, the silk meringue has a water content of at most 75%, at most 65%, at most 60%, at most 50%, at most 40%, or at most 25%.

### Compressed Silk Meringue

The present disclosure provides a compressed silk meringue comprising silk fibroin and xanthan gum and, in many cases, glycerol. In some aspects, the compressed silk meringue comprises silk fibroin, xanthan gum, and a plasticizer. In some aspects, the compressed silk meringue comprises silk fibroin, xanthan gum, and glycerol. In some aspects, the compressed silk meringue comprises silk fibroin, xanthan gum, a plasticizer, and a functionalizing agent. In some aspects, the compressed silk meringue comprises silk fibroin, xanthan gum, glycerol, and a functionalizing agent. In some aspects, the compressed silk meringue comprises silk fibroin, xanthan gum, and a functionalizing agent. In some aspects, the compressed silk meringue comprises a mixture of silk fibroin and a high molecular weight sugar (e.g., such as xanthan gum), and may optionally further include at least one of a plasticizer (e.g., such as glycerol) or a functionalizing agent.

Compositionally, the compressed silk meringue is generally the same as the silk meringue. Structurally, the compressed silk meringue has a reduced and/or compressed and/or damaged pore structure when compared with the silk meringue.

Many of the most preferred compressed silk meringues include glycerol, as its inclusion provides an impressive malleability, thereby allowing compression with the retention of the general material and pore structure of the silk meringue. Specifically, in some cases where glycerol is present, the compressed silk meringue is a mysilkium material. Specifically, in some cases where glycerol is present, the compressed silk meringue can be or can form a part of (e.g., one or two layers adhered to a fabric substrate) a silk leather. In an embodiment, meringues disclosed herein can be used as an alternative to polyurethane foams employed for artificial leathers.

Given that the compressed silk meringue is a downstream product from the silk meringue, the compressed silk meringue can include any component or feature of the silk meringue, unless the context clearly dictates otherwise (e.g., the porosity is reduced in the compressed silk meringue). Similarly, as all of the compressed silk meringue, the silk meringue, and the whipped silk cream derive from upstream entities, the compressed silk meringue can include any component or feature of the silk meringue, the whipped silk cream, or the liquid composition, unless the context clearly dictates otherwise.

The compressed silk meringue has a water content that can be tailored for specific uses. The compressed silk meringue has a water content of between 2% and 50%. In some cases, the compressed silk meringue has a water content of at least 2%, at least 5%, at least 10%, at least 15%, at least 20%, at least 25%, or at least 30%. In some cases, the compressed silk meringue has a water content of at most 50%, at most 45%, at most 40%, at most 35%, at most 30%, or at most 25%.

### Hot-Pressed Silk Meringue

The present disclosure provides a hot-pressed silk meringue comprising silk fibroin and xanthan gum and, in many cases, glycerol. In some aspects, the hot-pressed silk meringue comprises silk fibroin, xanthan gum, and glycerol. In some aspects, the hot-pressed silk meringue comprises silk fibroin, xanthan gum, and a plasticizer. In some aspects, the hot-pressed silk meringue comprises silk fibroin, xanthan gum, and glycerol. In some aspects, the hot-pressed silk meringue comprises silk fibroin, xanthan gum, a plasticizer, and a functionalizing agent. In some aspects, the hot-pressed silk meringue comprises silk fibroin, xanthan gum, glycerol, and a functionalizing agent. In some aspects, the hot-pressed silk meringue comprises silk fibroin, xanthan gum, and a functionalizing agent. In some aspects, the hot-pressed silk meringue comprises a mixture of silk fibroin and a high molecular weight sugar (e.g., such as xanthan gum), and may optionally further include at least one of a plasticizer (e.g., such as glycerol) or a functionalizing agent.

Compositionally, the hot-pressed silk meringue is generally the same as the silk meringue. Structurally, the hot-pressed silk meringue has a reduced and/or compressed and/or damaged pore structure when compared with the silk meringue.

Many of the most preferred hot-pressed silk meringues include glycerol, as its inclusion provides an impressive malleability, thereby allowing compression with the retention of the general material and pore structure of the silk meringue. Specifically, in some cases where glycerol is present, the hot-pressed silk meringue is a mysilkium material. Specifically, in some cases where glycerol is present, the hot-pressed silk meringue can be or can form a part of (e.g., one or two layers adhered to a fabric substrate) a silk leather. In an embodiment, meringues disclosed herein can be used as an alternative to polyurethane foams employed for artificial leathers.

Without wishing to be bound by any particular theory, it is believed that the most effective bonding between layers of material disclosed herein involves interlinking with mechanical structures (e.g., fibers in a woven fabric)

In some cases, the hot-pressed silk meringue (or other material format disclosed herein) can be interlinked with fabric, but in other cases the hot-pressed silk meringue is interlinked with a metal mesh, a conducting mesh, an electronic component, an active interface, an insulating interface, or a simple coating.

Given that the hot-pressed silk meringue is a downstream product from the silk meringue, the hot-pressed silk meringue can include any component or feature of the silk meringue, unless the context clearly dictates otherwise (e.g., the porosity is reduced in the hot-pressed silk meringue). Similarly, as all of the hot-pressed silk meringue, the silk meringue, and the whipped silk cream derive from upstream entities, the hot-pressed silk meringue can include any component or feature of the silk meringue, the whipped silk cream, or the liquid composition, unless the context clearly dictates otherwise.

The hot-pressed silk meringue has a water content that can be tailored for specific uses. The hot-pressed silk meringue has a water content of between 2% and 50%. In some cases, the hot-pressed silk meringue has a water content of at least 2%, at least 5%, at least 10%, at least 15%, at least 20%, at least 25%, or at least 30%. In some cases, the hot-pressed silk meringue has a water content of at most 50%, at most 45%, at most 40%, at most 35%, at most 30%, or at most 25%.

### Methods of Making

The present disclosure provides methods of making the various compositions, materials, and articles described herein.

In one case, the present disclosure provides a method of making a composition, such as a whipped silk cream. A method of making a whipped silk cream can include whipping a liquid comprising silk fibroin and xanthan gum (and, in many cases, plasticizer or functionalizing agent) for a predetermined whipping time to form the whipped silk cream. The predetermined whipping time can be between 5 minutes and 30 minutes, including but not limited to, at least 5 minutes, at least 6 minutes, at least 7 minutes, at least 8 minutes, at least 9 minutes, or at least 10 minutes and at most 30 minutes, at most 25 minutes, at most 20 minutes, at most 15 minutes, or at most 10 minutes.

The whipping can be achieved with mechanical agitation action that is associated with the integration of air, as would typically be understood from the context of food preparation involving various dairy and egg products, among other things. In some cases, the whipping is performed with a whisk. The whipping can optionally be performed manually, though there may be advantages to automated whipping, such as increased speed, endurance, and the like. The whipping can be performed using conventional whipping equipment or machines, such as a stand mixer. The whisk itself can be composed of metal or the whisk can be non-metal (or a metal whisk coated with a non-metal material, in some cases). The whipping can be done within a mixing bowl, such as a metal mixing bowl, for example a stainless steel mixing bowl.

In one specific case, the whipping involves whipping of a heterogenous solution, in which water and glycerol are the liquid phase and the silk fibroin and xanthan gum are in powder form.

In some cases, the temperature of the whipping is maintained at room temperature or lower, including refrigerated temperatures of between 1 °C and 25 °C.

In another case, the present disclosure provides a method of making a composition, such as a silk meringue. A method of making a silk meringue can include baking the whipped silk cream (optionally along with any method steps involved in preparing the whipped silk cream itself) at a temperature of between 25 °C and 150 °C, between 30 °C and 120 °C, or between 50 °C and 80 °C for a length of time of between 2 hours and 24 hours to form the silk meringue. In an example, the baking is performed at a temperature of between 40 °C and 150 °C for a length of time of between 5 minutes and 24 hours.

In some cases, the present disclosure provides a method of making an article, such as a compressed silk meringue. A method of making a compressed silk meringue can include compressing the silk meringue with a force of between 0.25 MPa and 25 MPa for a length of time of between 15 minutes and 6 hours. In some cases, the compressing can be heat-compressing that is performed at an elevated temperature of between 80 °C and 200 °C. In some cases, the compressing can be performed with a calendar press. A method of making a compressed silk meringue can include compressing the silk meringue with a force of between 0.25 MPa and 25 MPa for a length of time of between 5 minutes and 6 hours.

In some cases, the methods disclosed herein can further include embossing an article. The embossed article, such as an embossed silk leather, can have an appearance strikingly similar to embossed conventional leather.

The properties of silk creams, silk meringues, silk foams (baked silk creams), and articles of manufacture made from or including the silk creams, meringues, and or foams can be tuned by selection of weight ratios of starting materials, identity of starting materials, conditions of making the creams, meringues, and foams, and the like.

In some aspects, a method of making a whipped silk cream having a desired whipped silk cream morphology, a silk meringue having a desired silk meringue morphology, a compressed silk meringue having a desired compressed silk meringue morphology, or a hot-pressed silk meringue having a desired hot-pressed silk meringue morphology may include selecting a silk concentration, a silk molecular weight distribution, a polysaccharide species, a polysaccharide concentration, a plasticizer species, a plasticizer concentration, a whipping speed, optionally a silk meringue baking temperature, optionally a compressed silk meringue compressing force, optionally a hot-pressed silk meringue hot-pressing force and temperature. The method may further include making the whipped silk cream, the silk meringue, the compressed silk meringue, or the hot-pressed silk meringue using the silk concentration, the silk molecular weight distribution, the polysaccharide species, the polysaccharide concentration, the plasticizer species, the plasticizer concentration, the whipping speed, optionally the silk meringue baking temperature, optionally the compressed silk meringue compressing force, and optionally the hot-pressed silk meringue hot-pressing force and temperature.

For example, the density, water content, and syneresis of the creams can be varied based on the selected weight ratio of silk fibroin, polysaccharide, and plasticizer in the composition. For example, compositions to be used in food or pharmaceutical industries may be tuned to exhibit low syneresis, while compositions to be used in dried foams where mechanical stability is favored may be tuned to exhibit a higher amount of syneresis. In certain aspects, the polysaccharide may have the greatest impact on overall density, the silk fibroin may have the greatest impact on water content, and the plasticizer may have the greatest impact on syneresis. The discovery of these differential impacts enables the tuning of the composition in accordance with the desired application or the desired performance.

In another example, the properties of density, firmness, and overrun of the cream may vary with whipping time. For example, depending on the application, greater or less firmness may be desired, and whipping time may be used to tune the cream for the desired application.

In another example, the properties of a cream's density or overrun may be tuned by selection of a particular plasticizer species. In an aspect, higher numbers of —OH groups of a plasticizer, such as glycerol and 1-3-6 hexanetriol, reduces the whipping time to overrun plateau by efficiently facilitating a hydrogen bonding network between the silk fibroin and the polysaccharide. In another aspect, the distance of —OH groups in a plasticizer influences the air capacity of the foam—plasticizers such as diols (e.g., 1,2 and 1,5 pentanediol) exhibit slower cream growth with a significantly higher overrun when the OH groups are at a greater distance.

In some aspects, the properties of silk foams made from creams and/or meringues may also be tuned via the composition ratio. For example, varying the amount of plasticizer may have an effect on the foam's compressive strength and/or yield point. In another example, varying the polysaccharide species or combination of polysaccharides may be useful in tuning the foam for certain applications. For example, xanthan gum may be useful for applications where the foam is compressed (e.g., silk leather) where alginate may be more useful for foams being used in their expanded state.

In some aspects, the properties of silk foams made from creams and/or meringues may also be impacted by additives, such as borate ions which improve mechanical properties while providing flame retardant and anti-fungal properties.

In some aspects, varying the whipping time may have an effect on the resultant dried foam, such as due to the distribution of bubble sizes or the open/closed cell morphology. For example, longer whipping times may result in denser foams. As whipping time increases, cell structure may transition from a closed cell structure to an open cell structure. Variation in internal structure of foams may have an impact on performance in certain applications, such as in leather applications.

In an example method of making a composition, a liquid composition including a mixture of silk fibroin, a polysaccharide, and a plasticizer is whipped for a predetermined whipping time to form a whipped silk cream. In a further optional aspect of the example, the silk fibroin and the polysaccharide are whipped together before addition of the plasticizer. In another optional aspect of the example, the silk fibroin and the plasticizer are whipped together before addition of the polysaccharide. In still another optional aspect of the example, the polysaccharide and the plasticizer are whipped together before addition of the silk fibroin.

In certain cases the order of addition may be important, for example where highly hydrophobic compounds are used (e.g., fatty acids or oils). In these cases, the methods may include whipping a liquid composition including the silk fibroin and the polysaccharide for a first length of time before adding the highly hydrophobic compounds (optionally a plasticizer) and continuing the whipping.

### Articles of Manufacture

The present disclosure provides articles of manufactures that include or are made from one or more of the liquid compositions, whipped silk creams, silk meringues, compressed silk meringues, or hot-pressed silk meringues disclosed herein.

### Silk Leather

The present disclosure provides a silk leather. The silk leather is a layered structure comprising a first fabric layer and a second material layer disposed adjacent to the first fabric layer. The second material layer comprises the compressed silk meringue or the hot-pressed silk meringue disclosed herein. The silk leather optionally includes a third material layer disposed adjacent to the first fabric layer on a surface opposing the surface to which the second material layer is adjacent. The third material layer comprises the compressed silk meringue or the hot-pressed silk meringue disclosed herein. In effect, the compressed or hot-pressed silk meringues form a “sandwich” around the first fabric layer. In some embodiments, the silk leather comprises a first fabric layer and a second material layer disposed adjacent to the first fabric layer. In aspects, a silk leather optionally includes a third material layer disposed adjacent to the first fabric layer on a surface opposing the surface to which the second material layer is adjacent.

The first fabric layer can be composed of cotton fabric, including but not limited to, cotton jersey, cotton canvas, and the like; silk fabric; synthetic fabric, including but not limited to, polyester fabric, rayon fabric, nylon fabric, and the like; linen; organza; the like; and combinations thereof. In some examples, the first fabric layer may be treated with tannic acid.

In the aspects described herein, a unitary portion of silk leather may homogenously exhibit a property or functionality throughout the silk leather, or it may heterogeneously include various portions exhibiting one or more properties or functionalities (e.g., conductive, magnetic, colored, scented, tanned, patterned/embossed/textured, sensing/responsive (e.g., gas, humidity, thermochromic, pH), absorbing, thermal insulator, biological scaffold, electronics, semiconductor device-embedded, haptic, impact-resistant, heat-resistant, cold-resistant, or the like).

The silk leather can be colored to mimic non-colored natural leather. In some cases, the silk leather can be colored to mimic artificially colored natural leather. In one specific case, an artificial leather color can be produced by polymerizing phloroglucinol.

In some cases, using very cold water in making the whipped silk cream from which a silk leather is made can cause a thin “skin” to form on the surface, which can provide a wrinkled texture that mimics the texture of leather.

The present disclosure provides a thermal insulator. The thermal insulator comprises, consists essentially of, or consists of the silk meringue disclosed herein. The thermal insulator can be made by any of the methods disclosed herein. In aspects, thermally-insulating silk leather may have a thermochromic reporting property throughout a bulk interior volume.

The present disclosure provides a sorbent and/or gas sensing material. The sorbent and/or gas sensing material can comprise, consist essentially of, or consist of the silk meringue described herein. The sorbent and/or gas sensing material can further include a sensing agent that undergoes a measurable change upon exposure to a gas of interest. The sorbent and/or gas sensing material can include as a sensing agent a dye that changes color upon exposure to the gas of interest. The sorbent and/or gas-sensing material can be made by any of the methods disclosed herein.

The present disclosure provides a biological scaffold. In general, the biological scaffold is intended for the purpose of receiving a population of cells for one or more of growth, proliferation, differentiation, carbon dioxide capture, biomineralization, biosynthesis, fermentation, the like, and combinations thereof.

In one specific case, the biological scaffolds disclosed herein are particularly excellent for algae growth. Specifically, both marine and freshwater algae were seeded and successfully grown on scaffolds for at least a month at 90% relative humidity and under adequate lighting conditions.

In one particular case, the present disclosure provides a mysilkium material with material properties that closely mimic the material properties of mycelium. The mysilkium material can be used in applications where mycelium is currently used.

### Functionalizing/Active Agents

The compositions described herein can include a functionalizing agent, an active agent, a therapeutic agent, or a combination thereof.

According to various embodiments, a variety of functionalizing agents may be used with the silk-containing embodiments described herein (e.g., silk membrane, silk composition, silk articles, silk matrix, silk foam, silk microsphere, liquid composition, whipped silk cream, silk meringue, compressed silk meringue, hot-pressed silk meringue, silk leather, silk powder, silk toner, edible silk-based films, etc.). It should be understood that the examples herein may recite one or a few silk-containing embodiments but are applicable to any silk-containing embodiment, as applicable. In some embodiments, a functionalizing agent may be any compound or molecule that facilitates the attachment to and/or development (e.g., growth) of one or more endothelial cells on a silk membrane. In some embodiments, a functionalizing agent may be any compound or molecule that facilitates the attachment and/or development (e.g., growth) of one or more megakaryocytes and/or hematopoietic progenitor cells on a silk matrix and/or silk membrane. In some embodiments, a functionalizing agent may be or comprise an agent suitable for facilitating the production of one or more of white blood cells and red blood cells.

In some embodiments, a functionalizing agent may be or comprise a cell attachment mediator and/or an extracellular matrix protein, for example: collagen (e.g., collagen type I, collagen type III, collagen type IV, or collagen type VI), elastin, fibronectin, vitronectin, laminin, fibrinogen, von Willebrand factor, proteoglycans, decorin, perlecan, nidogen, hyaluronan, and/or peptides containing known integrin binding domains (e.g., “RGD” integrin binding sequence, or variations thereof), that are known to affect cellular attachment.

In some embodiments, a functionalizing agent may be any soluble molecule produced by endothelial cells. Non-limiting examples include fibroblast growth factor-1 (FGF1) and vascular endothelial growth factors (VEGF).

According to some embodiments, a plurality of functionalizing agents may be used. For example, in some embodiments wherein production of platelets is desired, provided compositions may comprise the use of laminin, fibronectin and/or fibrinogen, and type IV collagen in order to facilitate the attachment and growth of endothelial cells on a silk membrane (e.g., a porous silk membrane) and/or attachment of megakaryocytes to a silk matrix.

In some embodiments, a functionalizing agent may be embedded or otherwise associated with a silk membrane and/or silk matrix such that at least a portion of the functionalizing agent is surrounded by a silk membrane and/or silk matrix as contrasted to a functionalizing agent simply being positioned along the surface of a silk membrane and/or silk matrix. In some embodiments, a functionalizing agent is distributed along and/or incorporated in substantially the entire surface area of a silk membrane/silk wall. In some embodiments, a functionalizing agent is distributed and/or incorporated only at one or more discrete portions of a silk membrane/wall and/or silk matrix. In some embodiments, a functionalizing agent is distributed in and/or along at least one of the lumen-facing side of a silk wall and the matrix-facing side of a silk wall.

According to various embodiments, any application-appropriate amount of one or more functionalizing agents may be used. In some embodiments, the amount of an individual functionalizing agent may be between about 1 μg/mL and 1,000 μg/mL (e.g., between about 2 μg/mL and 1,000 μg/mL, 5 μg/mL and 1,000 μg/mL, 10 μg/mL and 1,000 μg/mL, 10 μg/mL and 500 μg/mL, 10 μg/mL and 100 μg/mL). In some embodiments, the amount of an individual functionalizing agent may be at least 1 μg/mL (e.g., at least 5 μg/mL, 10 μg/mL, 15 μg/mL, 20 μg/mL, 25 μg/mL, 50 μg/mL, 100 μg/mL, 200 μg/mL, 300 μg/mL, 400 μg/mL, 500 μg/mL, 600 μg/mL, 700 μg/mL, 800 μg/mL, or 900 μg/mL). In some embodiments, the amount of an individual functionalizing agent is at most 1,000 μg/mL (e.g., 900 μg/mL, 800 μg/mL, 700 μg/mL, 600 μg/mL, 500 μg/mL, 400 μg/mL, 300 μg/mL, 200 μg/mL, 100 μg/mL, 90 μg/mL, 80 μg/mL, 70 μg/mL, 60 μg/mL, 50 μg/mL, 40 μg/mL, 30 μg/mL, 20 μg/mL, 10 μg/mL, or 5 μg/mL).

In some aspects, the composition comprises one or more sensing agents, such as a sensing dye. The sensing agents/sensing dyes are environmentally sensitive and produce a measurable response to one or more environmental factors. In some aspects, the environmentally-sensitive agent or dye may be present in the composition in an effective amount to alter the composition from a first chemical-physical state to a second chemical-physical state in response to an environmental parameter (e.g., a change in pH, light intensity or exposure, temperature, pressure or strain, voltage, physiological parameter of a subject, and/or concentration of chemical species in the surrounding environment) or an externally applied stimulus (e.g., optical interrogation, acoustic interrogation, and/or applied heat). In some cases, the sensing dye is present to provide one optical appearance under one given set of environmental conditions and a second, different optical appearance under a different given set of environmental conditions. Suitable concentrations for the sensing agents described herein can be the concentrations for the colorants and additives described elsewhere herein. A person having ordinary skill in the chemical sensing arts can determine a concentration that is appropriate for use in a sensing application of the inks described herein.

In some aspects, the first and second chemical-physical state may be a physical property of the composition, such as a mechanical property, a chemical property, an acoustical property, an electrical property, a magnetic property, an optical property, a thermal property, a radiological property, or an organoleptic property. Exemplary sensing dyes or agents include, but are not limited to, a pH sensitive agent, a thermal sensitive agent, a pressure or strain sensitive agent, a light sensitive agent, or a potentiometric agent.

Exemplary pH sensitive dyes or agents include, but are not limited to, cresol red, methyl violet, crystal violet, ethyl violet, malachite green, methyl green, 2-(p-dimethylaminophenylazo)pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, Congo red, methyl orange, ethyl orange, 4-(4-dimethylamino-1-naphylazo)-3-methoxybenzenesulfonic acid, bromocresol green, resazurin, 4-phenylazo-1-napthylamine, ethyl red 2-(1-dimethylaminophenyazo) pyridine, 4-(p-ethoxyphenylazo)-m-phenylene-diamine monohydrochloride, resorcin blue, alizarin red S, methyl red, propyl red, bromocresol purple, chlorophenol red, p-nitrophenol, alizarin, 2-(2,4-dinitrophenylazo)-1-napthol-3,6-disulfonic acid, bromothymol blue, 6,8-dinitro-1H-quinazoline-2,4-dione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenzene, and clayton yellow.

Exemplary light responsive dyes or agents include, but are not limited to, photochromic compounds or agents, such as triarylmethanes, stilbenes, azastilbenes, nitrones, fulgides, spiropyrans, napthopyrans, spiro-oxazines, quinones, derivatives, and combinations thereof.

Exemplary potentiometric dyes include, but are not limited to, substituted amiononaphthylehenylpridinium (ANEP) dyes, such as di-4-ANEPPS, di-8-ANEPPS, and N-(4-Sulfobutyl)-4-(6-(4-(Dibutylamino)phenyl)hexatrienyl)Pyridinium (RH237).

Exemplary temperature sensitive dyes or agents include, but are not limited to, thermochromic compounds or agents, such as thermochromic liquid crystals, leuco dyes, fluoran dyes, octadecylphosphonic acid.

Exemplary pressure or strain sensitive dyes or agents include, but are not limited to, spiropyran compounds and agents.

Exemplary chemi-sensitive dyes or agents include, but are not limited to, antibodies such as immunoglobulin G (IgG) which may change color from blue to red in response to bacterial contamination.

In some aspects, the compositions comprise one or more additive, dopant, or biologically active agent suitable for a desired intended purpose. In some aspects, the additive or dopant may be present in the composition in an amount effective to impart an optical or organoleptic property to the composition. Exemplary additives or dopants that impart optical or organoleptic properties include, but are not limited to, dyes/pigments, flavorants, aroma compounds, granular or fibrous fillers.

Additionally or alternatively, the additive, dopant, or biologically active agent may be present in the composition in an amount effective to “functionalize” the composition to impart a desired mechanical property or added functionality to the composition. Exemplary additive, dopants, or biologically active agent that impart the desired mechanical property or added functionality include, but are not limited to: environmentally sensitive/sensing dyes; active biomolecules; conductive or metallic particles; micro and nanofibers (e.g., silk nanofibers for reinforcement, carbon nanofibers); nanotubes; inorganic particles (e.g., hydroxyapatite, tricalcium phosphate, bioglasses); drugs (e.g., antibiotics, small molecules, or low molecular weight organic compounds); proteins and fragments or complexes thereof (e.g., enzymes, antigens, antibodies, and antigen-binding fragments thereof); DNA/RNA (e.g., siRNA, miRNA, mRNA); cells and fractions thereof (viruses and viral particles; prokaryotic cells such as bacteria; eukaryotic cells such as mammalian cells and plant cells; fungi).

In some aspects, the additive or dopant comprises a flavoring agent or flavorant.

Exemplary flavorants include ester flavorants, amino acid flavorants, nucleic acid flavorants, organic acid flavorants, and inorganic acid flavorants, such as, but not limited to, diacetyl, acetyl propionyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manzanate, glutamic acid salts, glycine salts, guanylic acids salts, inosinic acid salts, acetic acid, ascorbic acid, citric acid, fumaric acid, lactic acid, malic acid, phosphoric acid, tartaric acid, derivatives, and mixtures thereof.

In some aspects, the additive or dopant comprises an aroma compound. Exemplary aroma compounds include ester aroma compounds, terpene aroma compounds, cyclic terpenes, and aromatic aroma compounds, such as, but not limited to, geranyl acetate, methyl formate, methyl acetate, methyl propionate, methyl butyrate, ethyl acetate, ethyl butyrate, isoamyl acetate, pentyl butyrate, pentyl pentanoate, octyl acetate, benzyl acetate, methyl anthranilate, myrcene, geraniol, nerol, citral, citronellal, cironellol, linalool, nerolidol, limonene, camphor, menthol, carone, terpineol, alpha-ionone, thujone, eucalyptol, benzaldehyde, eugenol, cinnamaldehyde, ethyl maltol, vanillin, anisole, anethole, estragole, thymol.

In some aspects, the additive or dopant comprises a colorant, such as a dye or pigment. In some aspects, the dye or pigment imparts a color or grayscale to the composition. The colorant can be different than the sensing agents and/or sensing dyes below. Any organic and/or inorganic pigments and dyes can be included in the inks. Exemplary pigments suitable for use in the present disclosure include International Color Index or C.I. Pigment Black Numbers 1, 7, 11, and 31, C.I. Pigment Blue Numbers 15, 15:1, 15:2, 15:3, 15:4, 15:6, 16, 27, 29, 61 and 62, C.I. Pigment Green Numbers 7, 17, 18 and 36, C.I. Pigment Orange Numbers 5, 13, 16, 34 and 36, C.I. Pigment Violet Numbers 3, 19, 23 and 27, C.I. Pigment Red Numbers 3, 17, 22, 23, 48:1, 48:2, 57:1, 81:1, 81:2, 81:3, 81:5, 101, 114, 122, 144, 146, 170, 176, 179, 181, 185, 188, 202, 206, 207, 210 and 249, C.I. Pigment Yellow Numbers 1, 2, 3, 12, 13, 14, 17, 42, 65, 73, 74, 75, 83, 30, 93, 109, 1 10, 128, 138, 139, 147, 142, 151, 154 and 180, D&C Red No. 7, D&C Red No. 6 and D&C Red No. 34, carbon black pigment (such as Regal 330, Cabot Corporation), quinacridone pigments (Quinacridone Magenta (228-0122), available from Sun Chemical Corporation, Fort Lee, N.J.), diarylide yellow pigment (such as AAOT Yellow (274-1788) available from Sun Chemical Corporation); and phthalocyanine blue pigment (such as Blue 15:3 (294-1298) available from Sun Chemical Corporation). The classes of dyes suitable for use in present invention can be selected from acid dyes, natural dyes, direct dyes (either cationic or anionic), basic dyes, and reactive dyes. The acid dyes, also regarded as anionic dyes, are soluble in water and mainly insoluble in organic solvents and are selected, from yellow acid dyes, orange acid dyes, red acid dyes, violet acid dyes, blue acid dyes, green acid dyes, and black acid dyes. European Patent 0745651, incorporated herein by reference, describes a number of acid dyes that are suitable for use in the present disclosure. Exemplary yellow acid dyes include Acid Yellow 1 International Color Index or C.I. 10316); Acid Yellow 7 (C.I. 56295); Acid Yellow 17 (C.I. 18965); Acid Yellow 23 (C.I. 19140); Acid Yellow 29 (C.I. 18900); Acid Yellow 36 (C.I. 13065); Acid Yellow 42 (C.I. 22910); Acid Yellow 73 (C.I. 45350); Acid Yellow 99 (C.I. 13908); Acid Yellow 194; and Food Yellow 3 (C.I. 15985). Exemplary orange acid dyes include Acid Orange 1 (C.I. 13090/1); Acid Orange 10 (C.I. 16230); Acid Orange 20 (C.I. 14603); Acid Orange 76 (C.I. 18870); Acid Orange 142; Food Orange 2 (C.I. 15980); and Orange B.

Exemplary red acid dyes include Acid Red 1 (C.I. 18050); Acid Red 4 (C.I. 14710); Acid Red 18 (C.I. 16255); Acid Red 26 (C.I. 16150); Acid Red 27 (C.I. 16185); Acid Red 51 (C.I. 45430, available from BASF Corporation, Mt. Olive, N.J.); Acid Red 52 (C.I. 45100); Acid Red 73 (C.I. 27290); Acid Red 87 (C.I. 45380); Acid Red 94 (C.I. 45440) Acid Red 194; and Food Red 1 (C.I. 14700). Exemplary violet acid dyes include Acid Violet 7 (C.I. 18055); and Acid Violet 49 (C.I. 42640). Exemplary blue acid dyes include Acid Blue 1 (C.I. 42045); Acid Blue 9 (C.I. 42090); Acid Blue 22 (C.I. 42755); Acid Blue 74 (C.I. 73015); Acid Blue 93 (C.I. 42780); and Acid Blue 158A (C.I. 15050). Exemplary green acid dyes include Acid Green 1 (C.I. 10028); Acid Green 3 (C.I. 42085); Acid Green 5 (C.I. 42095); Acid Green 26 (C.I. 44025); and Food Green 3 (C.I. 42053). Exemplary black acid dyes include Acid Black 1 (C.I. 20470); Acid Black 194 (Basantol® X80, available from BASF Corporation, an azo/l:2 CR-complex.

Exemplary direct dyes for use in the present disclosure include Direct Blue 86 (C.I. 74180); Direct Blue 199; Direct Black 168; Direct Red 253; and Direct Yellow 107/132 (C.I. Not Assigned).

Exemplary natural dyes for use in the present disclosure include Alkanet (C.I. 75520,75530); Annatto (C.I. 75120); Carotene (C.I. 75130); Chestnut; Cochineal (C.I.75470); Cutch (C.I. 75250, 75260); Divi-Divi; Fustic (C.I. 75240); Brazilin (C.I. 75280); Logwood (C.I. 75200); Osage Orange (C.I. 75660); Paprika; Quercitron (C.I. 75720); Saffron (C.I. 75100); Sandal Wood (C.I. 75510, 75540, 75550, 75560); Sumac; and Turmeric (C.I. 75300). Exemplary reactive dyes for use in the present disclosure include Reactive Yellow 37 (monoazo dye); Reactive Black 31 (diazo dye); Reactive Blue 77 (phthalo cyanine dye); and Reactive Red 180 and Reactive Red 108 dyes. Suitable also are the colorants described in The Printing Ink Manual (5th ed., Leach et al. eds. (2007), pages 289-299). Other organic and inorganic pigments and dyes and combinations thereof can be used to achieve the colors desired.

In addition to or in place of visible colorants, compositions provided herein can contain ETV fluorophores that are excited in the ETV range and emit light at a higher wavelength (typically 400 nm and above). Examples of ETV fluorophores include but are not limited to materials from the coumarin, benzoxazole, rhodamine, napthalimide, perylene, benzanthrones, benzoxanthones or benzothia-xanthones families. The addition of a UV fluorophore (such as an optical brightener for instance) can help maintain maximum visible light transmission. The amount of colorant, when present, generally is between 0.05% to 5% or between 0.1% and 1% based on the weight of the composition.

For non-white compositions, the amount of pigment/dye generally is present in an amount of from at or about 0.1 wt % to at or about 20 wt % based on the weight of the composition. In some applications, a non-white ink can include 15 wt % or less pigment/dye, or 10 wt % or less pigment/dye or 5 wt % pigment/dye, or 1 wt % pigment/dye based on the weight of the composition. In some applications, a non-white ink can include 1 wt % to 10 wt %, or 5 wt % to 15 wt %, or 10 wt % to 20 wt % pigment/dye based on the weight of the composition. In some applications, a non-white ink can contain an amount of dye/pigment that is 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt % or 20 wt % based on the weight of the composition.

For white compositions, the amount of white pigment generally is present in an amount of from at or about 1 wt % to at or about 60 wt % based on the weight of the composition. In some applications, greater than 60 wt % white pigment can be present. Preferred white pigments include titanium dioxide (anatase and rutile), zinc oxide, lithopone (calcined coprecipitate of barium sulfate and zinc sulfide), zinc sulfide, blanc fixe and alumina hydrate and combinations thereof, although any of these can be combined with calcium carbonate. In some applications, a white ink can include 60 wt % or less white pigment, 55 wt % or less white pigment, 50 wt % white pigment, 45 wt % white pigment, 40 wt % white pigment, 35 wt % white pigment, 30 wt % white pigment, 25 wt % white pigment, 20 wt % white pigment, 15 wt % white pigment, or 10 wt % white pigment, based on the weight of the composition. In some applications, a white ink can include 5 wt % to 60 wt %, 5 wt % to 55 wt %, 10 wt % to 50 wt %, 10 wt % to 25 wt %, 25 wt % to 50 wt %, 5 wt % to 15 wt %, or 40 wt % to 60 wt % white pigment based on the weight of the composition. In some applications, a non-white ink can an amount of dye/pigment that is 5 wt %, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt %, 20 wt %, 21 wt %, 22 wt %, 23 wt %, 24 wt %, 25%, 26 wt %, 27 wt %, 28 wt %, 29 wt %, 30 wt %, 31 wt %, 32 wt %, 33 wt %, 34 wt %, 35%, 36 wt %, 37 wt %, 38 wt %, 39 wt %, 40 wt %, 41 wt %, 42 wt %, 43 wt %, 44 wt %, 45%, 46 wt %, 47 wt %, 48 wt %, 49 wt %, 50 wt %, 51 wt %, 52 wt %, 53 wt %, 54 wt %, 55%, 56 wt %, 57 wt %, 58 wt %, 59 wt % or 60 wt % based on the weight of the composition.

In some aspects, the additive or dopant comprises a conductive additive. Exemplary conductive additives include, but are not limited to graphite, graphite powder, carbon nanotubes, and metallic particles or nanoparticles, such as gold nanoparticles. In some aspects, the conductive additive is biocompatible and non-toxic.

In some aspects, the additive is a biologically active agent. The term “biologically active agent” as used herein refers to any molecule which exerts at least one biological effect in vivo. For example, the biologically active agent can be a therapeutic agent to treat or prevent a disease state or condition in a subject. Biologically active agents include, without limitation, organic molecules, inorganic materials, proteins, peptides, nucleic acids (e.g., genes, gene fragments, gene regulatory sequences, and antisense molecules), nucleoproteins, polysaccharides, glycoproteins, and lipoproteins. Classes of biologically active compounds that can be incorporated into the composition provided herein include, without limitation, anticancer agents, antibiotics, analgesics, anti-inflammatory agents, immunosuppressants, enzyme inhibitors, antihistamines, anti-convulsants, hormones, muscle relaxants, antispasmodics, ophthalmic agents, prostaglandins, anti-depressants, anti-psychotic substances, trophic factors, osteoinductive proteins, growth factors, and vaccines.

The term “active agent” may also be used herein to refer to a biological sample (e.g., a sample of tissue or fluid, such as for instance blood) or a component thereof, and/or to a biologically active entity or compound, and/or to a structurally or functionally labile entity.

Exemplary active agents include, but are not limited to, therapeutic agents, diagnostic agents (e.g., contrast agents), and any combinations thereof. In some embodiments, the active agent present in a silk matrix (e.g., a silk microsphere), composition, or the like can include a labile active agent, e.g., an agent that can undergo chemical, physical, or biological change, degradation and/or deactivation after exposure to a specified condition, e.g., high temperatures, high humidity, light exposure, and any combinations thereof. In some embodiments, the active agent present in the silk matrix (e.g., a silk microsphere), composition, or the like can include a temperature-sensitive active agent, e.g., an active agent that will lose at least about 30% or more of its original activity or bioactivity, upon exposure to a temperature of at least about 10 °C or above, including at least about 15 °C or above, at least about room temperature or above, or at least about body temperature (e.g., about 37 °C) or above.

The active agent can be generally present in the silk matrix (e.g., a silk microsphere), composition, or the like in an amount of about 0.01% (w/w) to about 70% (w/w), about 0.1% (w/w) to about 50% (w/w), or about 1% (w/w) to about 30% (w/w). The active agent can be present on a surface of the silk matrix (e.g., a silk microsphere), composition, or the like and/or encapsulated and dispersed in the silk matrix (e.g., a silk microsphere), composition, or the like homogeneously, heterogeneously, or in a gradient. In some embodiments, the active agent can be added into the silk solution, which is then subjected to the methods described herein for preparing a silk matrix (e.g., a silk microsphere), composition, or the like. In some embodiments, the active agent can be coated on a surface of the silk matrix (e.g., a silk microsphere), composition, or the like. In some embodiments, the active agent can be loaded in a silk matrix (e.g., a silk microsphere), composition, or the like by incubating the silk microsphere in a solution of the active agent for a period of time, during which an amount of the active agent can diffuse into the silk matrix (e.g., a silk microsphere), composition, or the like, and thus distribute within the silk matrix (e.g., a silk microsphere), composition, or the like.

In some aspects, the additive is a therapeutic agent. As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term includes externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), nucleic acid analogues (e.g., locked nucleic acid (LNA), peptide nucleic acid (PNA), xeno nucleic acid (XNA)), or mixtures or combinations thereof, including, for example, DNA nanoplexes, siRNA, microRNA, shRNA, aptamers, ribozymes, decoy nucleic acids, antisense nucleic acids, RNA activators, and the like. Generally, any therapeutic agent can be included in the composition provided herein.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but upon administration to a subject are converted to biologically active agents through metabolism or some other mechanism. Additionally, a silk-based drug delivery composition can contain one therapeutic agent or combinations of two or more therapeutic agents.

A therapeutic agent can include a wide variety of different compounds, including chemical compounds and mixtures of chemical compounds, e.g., small organic or inorganic molecules; saccharides; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some aspects, the therapeutic agent is a small molecule.

The term “bioactivity,” as used herein in reference to an active agent, generally refers to the ability of an active agent to interact with a biological target and/or to produce an effect on a biological target. For example, bioactivity can include, without limitation, elicitation of a stimulatory, inhibitory, regulatory, toxic or lethal response in a biological target. The biological target can be a molecule or a cell. For example, a bioactivity can refer to the ability of an active agent to modulate the effect/activity of an enzyme, block a receptor, stimulate a receptor, modulate the expression level of one or more genes, modulate cell proliferation, modulate cell division, modulate cell morphology, or any combination thereof. In some instances, a bioactivity can refer to the ability of a compound to produce a toxic effect in a cell. Exemplary cellular responses include, but are not limited to, lysis, apoptosis, growth inhibition, and growth promotion; production, secretion, and surface expression of a protein or other molecule of interest by the cell; membrane surface molecule activation including receptor activation; transmembrane ion transports; transcriptional regulations; changes in viability of the cell; changes in cell morphology; changes in presence or expression of an intracellular component of the cell; changes in gene expression or transcripts; changes in the activity of an enzyme produced within the cell; and changes in the presence or expression of a ligand and/or receptor (e.g., protein expression and/or binding activity). Methods for assaying different cellular responses are well known to one of skill in the art, e.g., western blot for determining changes in presence or expression of an endogenous protein of the cell, or microscopy for monitoring the cell morphology in response to the active agent, or FISH and/or qPCR for the detection and quantification of changes in nucleic acids. Bioactivity can be determined in some embodiments, for example, by assaying a cellular response.

In reference to an antibody, the term “bioactivity” includes, but is not limited to, epitope or antigen binding affinity, the in vivo and/or in vitro stability of the antibody, the immunogenic properties of the antibody, e.g., when administered to a human subject, and/or the ability to neutralize or antagonize the bioactivity of a target molecule in vivo or in vitro. The aforementioned properties or characteristics can be observed or measured using art-recognized techniques including, but not limited to, scintillation proximity assays, ELISA, ORIGEN immunoassay (IGEN), fluorescence quenching, fluorescence ELISA, competitive ELISA, SPR analysis including, but not limited to, SPR analysis using a BIAcore biosensor, in vitro and in vivo neutralization assays (see, for example, International Publication No. WO 2006/062685), receptor binding, and immunohistochemistry with tissue sections from different sources including human, primate, or any other source as needed. In reference to an immunogen, the “bioactivity” includes immunogenicity, the definition of which is discussed in detail later. In reference to a virus, the “bioactivity” includes infectivity, the definition of which is discussed in detail later. In reference to a contrast agent, e.g., a dye, the “bioactivity” refers to the ability of a contrast agent when administered to a subject to enhance the contrast of structures or fluids within the subject's body. The bioactivity of a contrast agent also includes, but is not limited to, its ability to interact with a biological environment and/or influence the response of another molecule under certain conditions.

As used herein, the term “small molecule” can refer to compounds that are “natural product-like,” however, the term “small molecule” is not limited to “natural product-like” compounds. Rather, a small molecule is typically characterized in that it contains several carbon-carbon bonds and has a molecular weight of less than 5000 Daltons (5 kDa), preferably less than 3 kDa, still more preferably less than 2 kDa, and most preferably less than 1 kDa. In some cases, it is preferred that a small molecule has a molecular weight equal to or less than 700 Daltons.

Exemplary therapeutic agents include, but are not limited to, those found in Harrison's Principles of Internal Medicine, 13th Edition, Eds. T. R. Harrison et al. McGraw-Hill N.Y., NY; Physicians' Desk Reference, 50th Edition, 1997, Oradell New Jersey, Medical Economics Co.; Pharmacological Basis of Therapeutics, 8th Edition, Goodman and Gilman, 1990; United States Pharmacopeia, The National Formulary, ETSP XII NF XVII, 1990, the complete contents of all of which are incorporated herein by reference.

Therapeutic agents include the herein disclosed categories and specific examples. It is not intended that the category be limited by the specific examples. Those of ordinary skill in the art will recognize also numerous other compounds that fall within the categories and that are useful according to the present disclosure. Examples include a radiosensitizer, a steroid, a xanthine, a beta-2-agonist bronchodilator, an anti-inflammatory agent, an analgesic agent, a calcium antagonist, an angiotensin-converting enzyme inhibitors, a beta-blocker, a centrally active alpha-agonist, an alpha-1-antagonist, an anticholinergic/antispasmodic agent, a vasopressin analogue, an antiarrhythmic agent, an antiparkinsonian agent, an antiangina/antihypertensive agent, an anticoagulant agent, an antiplatelet agent, a sedative, an anxiolytic agent, a peptidic agent, a biopolymeric agent, an antineoplastic agent, a laxative, an antidiarrheal agent, an antimicrobial agent, an antifungal agent, a vaccine, a protein, or a nucleic acid. In a further aspect, the pharmaceutically active agent can be coumarin, albumin, steroids such as betamethasone, dexamethasone, methylprednisolone, prednisolone, prednisone, triamcinolone, budesonide, hydrocortisone, and pharmaceutically acceptable hydrocortisone derivatives; xanthines such as theophylline and doxophylline; beta-2-agonist bronchodilators such as salbutamol, fenterol, clenbuterol, bambuterol, and salmeterol; anti-inflammatory agents, including antiasthmatic anti-inflammatory agents, antiarthritis anti-inflammatory agents, and non-steroidal anti-inflammatory agents, examples of which include but are not limited to sulfides, mesalamine, budesonide, salazopyrin, diclofenac, pharmaceutically acceptable diclofenac salts, nimesulide, naproxen, acetaminophen, ibuprofen, ketoprofen and piroxicam; analgesic agents such as salicylates; calcium channel blockers such as nifedipine, amlodipine, and nicardipine; angiotensin converting enzyme inhibitors such as captopril, benazepril hydrochloride, fosinopril sodium, trandolapril, ramipril, lisinopril, enalapril, quinapril hydrochloride, and moexipril hydrochloride; beta-blockers (i.e., beta adrenergic blocking agents) such as sotalol hydrochloride, timolol maleate, esmolol hydrochloride, carteolol, propanolol hydrochloride, betaxolol hydrochloride, penbutolol sulfate, metoprolol tartrate, metoprolol succinate, acebutolol hydrochloride, atenolol, pindolol, and bisoprolol fumarate; centrally active alpha-2-agonists such as clonidine; alpha-1-antagonists such as doxazosin and prazosin; anticholinergic/antispasmodic agents such as dicyclomine hydrochloride, scopolamine hydrobromide, glycopyrrolate, clidinium bromide, flavoxate, and oxybutynin; vasopressin analogues such as vasopressin and desmopressin; antiarrhythmic agents such as quinidine, lidocaine, tocainide hydrochloride, mexiletine hydrochloride, digoxin, verapamil hydrochloride, propafenone hydrochloride, flecainide acetate, procainamide hydrochloride, moricizine hydrochloride, and disopyramide phosphate; antiparkinsonian agents, such as dopamine, L-Dopa/Carbidopa, selegiline, dihydroergocryptine, pergolide, lisuride, apomorphine, and bromocriptine; antiangina agents and antihypertensive agents such as isosorbide mononitrate, isosorbide dinitrate, propranolol, atenolol and verapamil; anticoagulant and antiplatelet agents such as coumadin, warfarin, acetylsalicylic acid, and ticlopidine; sedatives such as benzodiazepines and barbiturates; anxiolytic agents such as lorazepam, bromazepam, and diazepam; peptidic and biopolymeric agents such as calcitonin, leuprolide and other LHRH agonists, hirudin, cyclosporin, insulin, somatostatin, protirelin, interferon, desmopressin, somatotropin, thymopentin, pidotimod, erythropoietin, interleukins, melatonin, granulocyte/macrophage-CSF, and heparin; antineoplastic agents such as etoposide, etoposide phosphate, cyclophosphamide, methotrexate, 5-fluorouracil, vincristine, doxorubicin, cisplatin, hydroxyurea, leucovorin calcium, tamoxifen, flutamide, asparaginase, altretamine, mitotane, and procarbazine hydrochloride; laxatives such as senna concentrate, casanthranol, bisacodyl, and sodium picosulphate; antidiarrheal agents such as difenoxin hydrochloride, loperamide hydrochloride, furazolidone, diphenoxylate hydrochloride, and microorganisms; vaccines such as bacterial and viral vaccines; antimicrobial agents such as penicillins, cephalosporins, and macrolides, antifungal agents such as imidazolic and triazolic derivatives; and nucleic acids such as DNA sequences encoding for biological proteins, and antisense oligonucleotides.

Anti-cancer agents include alkylating agents, platinum agents, antimetabolites, topoisomerase inhibitors, antitumor antibiotics, antimitotic agents, aromatase inhibitors, thymidylate synthase inhibitors, DNA antagonists, farnesyltransferase inhibitors, pump inhibitors, histone acetyltransferase inhibitors, metalloproteinase inhibitors, ribonucleoside reductase inhibitors, TNF alpha agonists/antagonists, endothelin A receptor antagonists, retinoic acid receptor agonists, immuno-modulators, hormonal and antihormonal agents, photodynamic agents, and tyrosine kinase inhibitors.

Antibiotics include aminoglycosides (e.g., gentamicin, tobramycin, netilmicin, streptomycin, amikacin, neomycin), bacitracin, carbapenems (e.g., imipenem/cilastatin), cephalosporins, colistin, methenamine, monobactams (e.g., aztreonam), penicillins (e.g., penicillin G, penicillin V, methicillin, nafcillin, oxacillin, cloxacillin, dicloxacillin, ampicillin, amoxicillin, carbenicillin, ticarcillin, piperacillin, mezlocillin, azlocillin), polymyxin B, quinolones, and vancomycin; and bacteriostatic agents such as chloramphenicol, clindamycin, macrolides (e.g., erythromycin, azithromycin, clarithromycin), lincomycin, nitrofurantoin, sulfonamides, tetracyclines (e.g., tetracycline, doxycycline, minocycline, demeclocycline), and trimethoprim. Also included are metronidazole, fluoroquinolones, and rifampin.

Enzyme inhibitors are substances which inhibit an enzymatic reaction. Examples of enzyme inhibitors include edrophonium chloride, N-methylphysostigmine, neostigmine bromide, physostigmine sulfate, tacrine, 1-hydroxymaleate, iodotubercidin, p-bromotetranisole, 10-(alpha-diethylaminopropionyl)-phenothiazine hydrochloride, calmidazolium chloride, hemicholinium-3,3,5-dinitrocatechol, diacylglycerol kinase inhibitor I, diacylglycerol kinase inhibitor II, 3-phenylpropargylamine, N^{o}-monomethyl-L-arginine acetate, carbidopa, 3-hydroxybenzylhydrazine, hydralazine, clorgyline, deprenyl, hydroxylamine, iproniazid phosphate, 6-MeO-tetrahydro-9H-pyrido-indole, nialamide, pargyline, quinacrine, semicarbazide, tranylcypromine, N,N-diethylaminoethyl-2,2-diphenylvalerate hydrochloride, 3-isobutyl-1-methylxanthine, papaverine, indomethacin, 2-cyclooctyl-2-hydroxyethylamine hydrochloride, 2,3-dichloro-a-methylbenzylamine (DCMB), 8,9-dichloro-2,3,4,5-tetrahydro-1H-2-benzazepine hydrochloride, p-aminoglutethimide, p-aminoglutethimide tartrate, 3-iodotyrosine, alpha-methyltyrosine, acetazolamide, dichlorphenamide, 6-hydroxy-2-benzothiazolesulfonamide, and allopurinol.

Antihistamines include pyrilamine, chlorpheniramine, and tetrahydrozoline, among others.

Anti-inflammatory agents include corticosteroids, nonsteroidal anti-inflammatory drugs (e.g., aspirin, phenylbutazone, indomethacin, sulindac, tolmetin, ibuprofen, piroxicam, and fenamates), acetaminophen, phenacetin, gold salts, chloroquine, D-Penicillamine, methotrexate colchicine, allopurinol, probenecid, and sulfinpyrazone.

Muscle relaxants include mephenesin, methocarbamol, cyclobenzaprine hydrochloride, trihexyphenidyl hydrochloride, levodopa/carbidopa, and biperiden.

Anti-spasmodics include atropine, scopolamine, oxyphenonium, and papaverine.

Analgesics include aspirin, phenylbutazone, indomethacin, sulindac, tolmetin, ibuprofen, piroxicam, fenamates, acetaminophen, phenacetin, morphine sulfate, codeine sulfate, meperidine, nalorphine, opioids (e.g., codeine sulfate, fentanyl citrate, hydrocodone bitartrate, loperamide, morphine sulfate, noscapine, norcodeine, normorphine, thebaine, nor-binaltorphimine, buprenorphine, chlornaltrexamine, funaltrexamine, nalbuphine, nalorphine, naloxone, naloxonazine, naltrexone, and naltrindole), procaine, lidocaine, tetracaine and dibucaine. Ophthalmic agents include sodium fluorescein, rose bengal, methacholine, adrenaline, cocaine, atropine, alpha-chymotrypsin, hyaluronidase, betaxolol, pilocarpine, timolol, timolol salts, and combinations thereof.

Prostaglandins are art recognized and are a class of naturally occurring chemically related long-chain hydroxy fatty acids that have a variety of biological effects.

Anti-depressants are substances capable of preventing or relieving depression.

Examples of anti-depressants include imipramine, amitriptyline, nortriptyline, protriptyline, desipramine, amoxapine, doxepin, maprotiline, tranylcypromine, phenelzine, and isocarboxazid.

Trophic factors are factors whose continued presence improves the viability or longevity of a cell trophic factors include, without limitation, platelet-derived growth factor (PDGP), neutrophil-activating protein, monocyte chemoattractant protein, macrophage-inflammatory protein, platelet factor, platelet basic protein, and melanoma growth stimulating activity; epidermal growth factor, transforming growth factor (alpha), fibroblast growth factor, platelet-derived endothelial cell growth factor, insulin-like growth factor, glial derived growth neurotrophic factor, ciliary neurotrophic factor, nerve growth factor, bone growth/cartilage-inducing factor (alpha and beta), bone morphogenetic proteins, interleukins (e.g., interleukin inhibitors or interleukin receptors, including interleukin 1 through interleukin 10), interferons (e.g., interferon alpha, beta and gamma), hematopoietic factors, including erythropoietin, granulocyte colony stimulating factor, macrophage colony stimulating factor and granulocyte-macrophage colony stimulating factor; tumor necrosis factors, and transforming growth factors (beta), including beta-1, beta-2, beta-3, inhibin, and activin.

Hormones include estrogens (e.g., estradiol, estrone, estriol, diethylstilbestrol, quinestrol, chlorotrianisene, ethinyl estradiol, mestranol), anti-estrogens (e.g., clomiphene, tamoxifen), progestins (e.g., medroxyprogesterone, norethindrone, hydroxyprogesterone, norgestrel), antiprogestin (mifepristone), androgens (e.g., testosterone cypionate, fluoxymesterone, danazol, testolactone), anti-androgens (e.g., cyproterone acetate, flutamide), thyroid hormones (e.g., triiodothyronne, thyroxine, propylthiouracil, methimazole, and iodixode), and pituitary hormones (e.g., corticotropin, somatotropin, oxytocin, and vasopressin). Hormones are commonly employed in hormone replacement therapy and/or for purposes of birth control. Steroid hormones, such as prednisone, are also used as immunosuppressants and anti-inflammatories. In some aspects, the additive is an agent that stimulates tissue formation, and/or healing and regrowth of natural tissues, and any combinations thereof. Agents that increase formation of new tissues and/or stimulates healing or regrowth of native tissue at the site of injection can include, but are not limited to, fibroblast growth factor (FGF), transforming growth factor-beta (TGF-beta, platelet-derived growth factor (PDGF), epidermal growth factors (EGFs), connective tissue activated peptides (CTAPs), osteogenic factors including bone morphogenic proteins, heparin, angiotensin II (A-II) and fragments thereof, insulin-like growth factors, tumor necrosis factors, interleukins, colony stimulating factors, erythropoietin, nerve growth factors, interferons, biologically active analogs, fragments, and derivatives of such growth factors, and any combinations thereof.

In some aspects, the silk composition can further comprise at least one additional material for soft tissue augmentation, e.g., dermal filler materials, including, but not limited to, poly(methyl methacrylate) microspheres, hydroxyapatite, poly(L-lactic acid), collagen, elastin, and glycosaminoglycans, hyaluronic acid, commercial dermal filler products such as BOTOX® (from Allergan), DYSPORT®, COSMODERM®, EVOLENCE®, RADIESSE®,RESTYLANE®, JUVEDERM® (from Allergan), SCULPTRA®, PERLANE®, and CAPTIQEIE®, and any combinations thereof.

In some aspects, the additive is a wound healing agent. As used herein, a “wound healing agent” is a compound or composition that actively promotes wound healing process.

Exemplary wound healing agents include, but are not limited to dexpanthenol; growth factors; enzymes; hormones; povidon-iodide; fatty acids; anti-inflammatory agents; antibiotics; antimicrobials; antiseptics; cytokines; thrombin; analgesics; opioids; aminoxyls; furoxans; nitrosothiols; nitrates and anthocyanins; nucleosides, such as adenosine; and nucleotides, such as adenosine diphosphate (ADP) and adenosine triphosphate (ATP); neurotransmitter/neuromodulators, such as acetylcholine and 5-hydroxytryptamine (serotonin/5-HT); histamine and catecholamines, such as adrenalin and noradrenalin; lipid molecules, such as 5-sphingosine-1-phosphate and lysophosphatidic acid; amino acids, such as arginine and lysine; peptides such as the bradykinins, substance P and calcium gene-related peptide (CGRP); nitric oxide; and any combinations thereof.

In certain aspects, the active agents provided herein are immunogens. In one aspect, the immunogen is a vaccine. Most vaccines are sensitive to environmental conditions under which they are stored and/or transported. For example, freezing may increase reactogenicity (e.g., capability of causing an immunological reaction) and/or loss of potency for some vaccines (e.g., HepB, and DTaP/IPV/FQB), or cause hairline cracks in the container, leading to contamination. Further, some vaccines (e.g., BCG, Varicella, and MMR) are sensitive to heat. Many vaccines (e.g., BCG, MMR, Varicella, Meningococcal C Conjugate, and most DTaP-containing vaccines) are light sensitive. See, e.g., Galazka et al., Thermostability of vaccines, in Global Programme for Vaccines & Immunization (World Health Organization, Geneva, 1998); Peetermans et al., Stability of freeze-dried rubella virus vaccine (Cendehill strain) at various temperatures, J. Biological Standardization 179 (1973). Thus, the compositions and methods provided herein also provide for stabilization of vaccines regardless of the cold chain and/or other environmental conditions.

In some aspects, the additive is a cell, e.g., a biological cell. Cells useful for incorporation into the composition can come from any source, e.g., mammalian, insect, plant, etc. In some aspects, the cell can be a human, rat or mouse cell. In general, cells to be used with the compositions provided herein can be any types of cells. In general, the cells should be viable when encapsulated within compositions. In some aspects, cells that can be used with the composition include, but are not limited to, mammalian cells (e.g. human cells, primate cells, mammalian cells, rodent cells, etc.), avian cells, fish cells, insect cells, plant cells, fungal cells, spore cells, bacterial cells, and hybrid cells. In some aspects, exemplary cells that can be used with the compositions include platelets, activated platelets, stem cells, totipotent cells, pluripotent cells, and/or embryonic stem cells. In some aspects, exemplary cells that can be encapsulated within compositions include, but are not limited to, primary cells and/or cell lines from any tissue. For example, cardiomyocytes, myocytes, hepatocytes, keratinocytes, melanocytes, neurons, astrocytes, embryonic stem cells, adult stem cells, hematopoietic stem cells, hematopoietic cells (e.g. monocytes, neutrophils, macrophages, etc.), ameloblasts, fibroblasts, chondrocytes, osteoblasts, osteoclasts, neurons, sperm cells, egg cells, liver cells, epithelial cells from lung, epithelial cells from gut, epithelial cells from intestine, liver, epithelial cells from skin, etc., and/or hybrids thereof, can be included in the silk/platelet compositions disclosed herein. Those skilled in the art will recognize that the cells listed herein represent an exemplary, not comprehensive, list of cells. Cells can be obtained from donors (allogenic) or from recipients (autologous). Cells can be obtained, as a non-limiting example, by biopsy or other surgical means known to those skilled in the art.

In some aspects, the cell can be a genetically modified cell. A cell can be genetically modified to express and secrete a desired compound, e.g. a bioactive agent, a growth factor, differentiation factor, cytokines, and the like. Methods of genetically modifying cells for expressing and secreting compounds of interest are known in the art and easily adaptable by one of skill in the art.

Differentiated cells that have been reprogrammed into stem cells can also be used. For example, human skin cells reprogrammed into embryonic stem cells by the transduction of Oct3/4, Sox2, c-Myc and Klf4 (Junying Yu, et. ah, Science, 2007, 318, 1917-1920 and Takahashi K. et. al, Cell, 2007, 131, 1-12).

For the avoidance of doubt, the components listed in this section are combinable with all forms of composition described herein, including liquid composition, whipped silk cream, any form of silk meringue, silk leather, or a combination thereof.

### Conductive Silk Leather

The present disclosure provides a conductive silk leather. Conductive silk leathers may be used to power embedded lights, for central processing for distributed sensors, and as a component of circuitry. In aspects, a unitary portion of silk leather may include portions that are conductive and portions that are not conductive.

Conductive silk leathers can be used with any other product or article of manufacture described herein. For example, the conductive silk leather can further include sorbent and/or gas sensing material, such as for example to provide a safety garment for a hazardous environment with embedded, powered lights and gas sensing capabilities. In another example, conductive silk leathers can be used with magnetic silk leathers, described elsewhere herein, to form a multi-functional item with magnetic and conductive properties. In some aspects, the conductive silk leather may also include materials, such as magnetic particles or chromium oxide, to render it both conductive and magnetic. Conductive silk leathers can be used with or include a thermal insulator to provide items with conductive and thermal insulation properties.

The conductive silk leather can comprise, consist essentially of, or consist of any of the silk meringues described herein. In aspects, at least one of a plurality of graphite flakes or a graphene powder is distributed within the compressed silk meringue or the hot-pressed silk meringue of the conductive silk leather. The graphite flakes or graphene powder may be added before or during the whipping process, or after whipping. In one example, graphite flakes or graphene powder are added when the whipped silk cream reaches a particular overrun value. The graphite flakes or graphene powder may be added before or during meringue formation or may be added before or during compression or hot-pressing the meringue.

In some aspects, the conductive silk leather includes a conductive ink. For example, the conductive ink is printed on a surface of the compressed silk meringue or the hot-pressed silk meringue. In another example, the conductive ink is printed between layers of the compressed silk meringue or the hot-pressed silk meringue or printed and subsequently embedded within the compressed silk meringue or the hot-pressed silk meringue. In yet another example, the conductive ink is printed between the compressed silk meringue or the hot-pressed silk meringue and a fabric layer. The conductivity is patterned into an electronic circuit. The resistivity of the conductive silk leather is at most 1kΩ, at most 0.7kΩ, at most 0.5kΩ, or at most 0.1kΩ.

For the avoidance of doubt, the conductive silk leathers described herein can wholly include or include features of the silk leathers disclosed elsewhere here. Similarly, the conductive silk leathers described herein can be made from, comprise, wholly include, or include features from the liquid compositions, whipped silk creams, silk meringues, compressed silk meringues, hot-pressed silk meringues, or methods disclosed elsewhere herein.

### Magnetic Silk Leather

The present disclosure provides a magnetic silk leather. The magnetic silk leather can comprise, consist essentially of, or consist of any of the silk meringues described herein. In aspects, at least one of a plurality of magnetic particles or a plurality of chromium oxide particles is distributed within the compressed silk meringue or the hot-pressed silk meringue. The plurality of magnetic particles or plurality of chromium oxide particles may be added before or during the whipping process, or after whipping. In one example, plurality of magnetic particles or plurality of chromium oxide particles are added when the whipped silk cream reaches a particular overrun value. The plurality of magnetic particles or plurality of chromium oxide particles may be added before or during meringue formation or may be added before or during compression or hot-pressing the meringue. In an aspect, a magnetic field may be applied at any point during the processing of the liquid composition to a silk whipped cream and silk meringues. Magnetic silk leathers can block RFID signals or be a building block for products such as robots, games, home organizing/décor, or the like.

The magnetic silk leather can be tailored to have a specific polarity at a surface of the magnetic silk leather. In some cases, the polarity is North. In some cases, the polarity is South.

In some cases, the magnetic material may be manipulated prior to curing, such that a specific magnetic configuration is locked into the magnetic silk leather. Conceptually, applications involving ferrofluids such as generating different patterns could be applied to creation of magnetic silk foams/meringues/leathers. In general, a magnetic field could be applied at any step of the methods disclosed herein with the intention of manipulating magnetic particles located within one or more of the compositions disclosed herein.

In some cases, the magnetic silk leather can be used as an external surface for a robot (e.g., a “robot skin”).

For the avoidance of doubt, the magnetic silk leathers described herein can wholly include or include features of the silk leathers disclosed elsewhere here. Similarly, the magnetic silk leathers described herein can be made from, comprise, wholly include, or include features from the liquid compositions, whipped silk creams, silk meringues, compressed silk meringues, hot-pressed silk meringues, or methods disclosed elsewhere herein.

### Scented Silk Leather

The present disclosure provides a scented silk leather. The scented silk leather can comprise, consist essentially of, or consist of any of the silk meringues described herein. In aspects, a plurality of aromatic compounds are distributed throughout the compressed silk meringue or the hot-pressed silk meringue of the scented silk leather.

The aromatic compounds may include emulsions, oils, alcohols, scented powder, or the like. The character of the aromatic compounds can impact the processing and the methods disclosed herein may afford different processing requirements. Both oil and alcohols can be freely incorporated into creams during the whipping, especially if the fragrance is concentrated (e.g., such as if the oil/alcohol is less than 5% of total volume). For adsorbing the fragrance on a dry material (e.g., meringue or leather), both oils and alcohols may be useful, but the permeability of the material would be controlled by the nature and content of the plasticizer. For example, foams with no glycerol (e.g., pure silk fibroin and xanthan gum) display a higher oil sorption capacity.

Applying an additional volume of the aromatic compound to a surface of the scented silk leather, such as by spraying, wiping, submerging, or other application method, may at least partly recharge the scented silk leather, thereby extending the lifetime of aroma release. In some cases, alcohol-based aroma compounds can be particularly effective at recharging scented silk leathers.

The aromatic compounds may be added before or during the whipping process, or after whipping. In one example, aromatic compounds are added when the whipped silk cream reaches a particular overrun value. The aromatic compounds may be added before or during meringue formation or may be added before or during compression or hot-pressing the meringue.

The silk foam can exhibit heterogeneous domains of scent such that scent intensity can be distributed based on foam particles. Through compression, gradients of scent may be generated. In one aspect, the scented silk leather exhibits pressure-sensitive aroma release.

The ability of a silk leather to become scented, maintain scent, release/dispense/disperse scent, and/or recharge scent may depend on factors such as the components of the liquid composition, the density, the water content, the presence of other agents/additives in the silk leather, or the like. Likewise, the release profile of scents may depend on similar factors.

For the avoidance of doubt, the scented silk leathers described herein can wholly include or include features of the silk leathers disclosed elsewhere here. Similarly, the scented silk leathers described herein can be made from, comprise, wholly include, or include features from the liquid compositions, whipped silk creams, silk meringues, compressed silk meringues, hot-pressed silk meringues, or methods disclosed elsewhere herein.

### pH Responsive Silk Leather

The present disclosure provides a pH-responsive silk leather. The pH-responsive silk leather can comprise, consist essentially of, or consist of any of the silk meringues described herein. In aspects, a pH-responsive chemical is distributed throughout the compressed silk meringue or the hot-pressed silk meringue of the pH-responsive silk leather. The pH-responsive chemical may be added before or during the whipping process, or after whipping. In one example, a pH-responsive chemical is added when the whipped silk cream reaches a particular overrun value. The pH-responsive chemical may be added before or during meringue formation or may be added before or during compression or hot-pressing the meringue. pH-responsive silk leather may be useful in worn garments such as to alert a wearer of certain ambient or precipitating pollutants.

For the avoidance of doubt, the pH-responsive silk leathers described herein can wholly include or include features of the silk leathers disclosed elsewhere here. Similarly, the pH-responsive silk leathers described herein can be made from, comprise, wholly include, or include features from the liquid compositions, whipped silk creams, silk meringues, compressed silk meringues, hot-pressed silk meringues, or methods disclosed elsewhere herein.

### Humidity Sensing Silk Leather

The present disclosure provides a humidity sensing silk leather. The humidity sensing silk leather can comprise, consist essentially of, or consist of any of the silk meringues described herein. In aspects, a pH responsive chemical (e.g., o-cresolphtalein) and a pH altering agent (e.g., sodium carbonate) are distributed throughout the compressed silk meringue or the hot-pressed silk meringue of the humidity sensing silk leather. In aspects, measurable amounts of humidity solubilize at least a portion of the pH altering agent, thereby lowering the pH, thereby providing a measurable report of humidity. At least one of the pH responsive chemical or the pH altering agent may be added before or during the whipping process, or after whipping. In one example, at least one of the pH responsive chemical or the pH altering agent are added when the whipped silk cream reaches a particular overrun value. At least one of the pH responsive chemical or the pH altering agent may be added before or during meringue formation or may be added before or during compression or hot-pressing the meringue. Humidity sensing silk leathers may be useful, for example, as a component of a humidor box.

For the avoidance of doubt, the humidity sensing silk leathers described herein can wholly include or include features of the silk leathers disclosed elsewhere here. Similarly, the humidity sensing silk leathers described herein can be made from, comprise, wholly include, or include features from the liquid compositions, whipped silk creams, silk meringues, compressed silk meringues, hot-pressed silk meringues, or methods disclosed elsewhere herein.

### Patterned Silk Leather

The present disclosure provides a patterned silk leather. The patterned silk leather can comprise, consist essentially of, or consist of any of the silk meringues described herein. Patterned silk leathers may exhibit any pattern or texture, such as for example to mimic reptile skin in appearance and/or feeling. Certain patterns or textures may provide an aesthetic quality and/or a function/property to silk leather, such as improved grip, anti-bacterial, anti-fouling, water-repellent, waterproof, dust-repellent, or the like. The dimensions of the patterns may be nano-, micro-, or macro-scale.

Examples of suitable surface patterns include, but are not limited to: leather mimicking patterns, which mimics a variety of different leathers, including alligator leather, crocodile leather, snake leather, cow leather, stingray leather, ostrich leather; a water-resistant or water-proof pattern; tessellating patterns; optically-active patterns, such as diffraction patterns; plant patterns, geometric patterns, letters and numbers, or the like.

For the avoidance of doubt, the patterned silk leathers described herein can wholly include or include features of the silk leathers disclosed elsewhere here. Similarly, the patterned silk leathers described herein can be made from, comprise, wholly include, or include features from the liquid compositions, whipped silk creams, silk meringues, compressed silk meringues, hot-pressed silk meringues, or methods disclosed elsewhere herein.

### Electronic Embedded Silk Leather

The present disclosure provides an electronic silk leather having an electronic component embedded therein. The electronic silk leather can comprise, consist essentially of, or consist of any of the silk meringues described herein. In aspects, the electronic component or a second electronic component is embedded between the silk layer and the fabric layer in the electronic silk leather. In aspects, the electronic component or a third electronic component is embedded within the silk layer in the electronic silk leather. In aspects, the electronic silk leather further comprises a power supply coupled to the electronic component. For example, the power supply may be a rechargeable battery, a wired disposable battery holder, fiber-shaped solar cells (e.g., perovskite solar cells), or a combination thereof. In aspects, the electronic component comprises an RFID tag. In aspects, the electronic component comprises wiring. The present disclosure also provides a silk cream or silk meringue having electronics distributed throughout. In aspects, the silk cream or silk meringue may be a variable density filler material having electronic functionalization. In embodiments, electronic components may include light emitting devices such as LEDs or electroluminescent wires. Such components may be useful in fashion and design applications as well as for powering sensing applications.

For the avoidance of doubt, the electronic silk leathers described herein can wholly include or include features of the silk leathers disclosed elsewhere here. Similarly, the electronic silk leathers described herein can be made from, comprise, wholly include, or include features from the liquid compositions, whipped silk creams, silk meringues, compressed silk meringues, hot-pressed silk meringues, or methods disclosed elsewhere herein.

### Semiconductor Device Embedded Silk Leather

The present disclosure provides a semiconductor device-embedded silk leather having a semiconductor device embedded therein. The semiconductor device-embedded silk leather can comprise, consist essentially of, or consist of any of the silk meringues described herein. The semiconductor device or a second semiconductor device may be embedded at a surface of the compressed silk meringue or the hot-pressed silk meringue. The semiconductor device or a third semiconductor device may be embedded within the compressed silk meringue or the hot-pressed silk meringue. The semiconductor device or a fourth semiconductor device may be embedded between the first fabric layer and the compressed silk meringue or the hot-pressed silk meringue. In aspects, the semiconductor device-embedded silk further comprises a power supply, as described elsewhere herein, coupled to the semiconductor devices. In aspects, the semiconductor device may be in communication with one or more electronic components in the silk leather.

For the avoidance of doubt, the semiconductor device-embedded silk leathers described herein can wholly include or include features of the silk leathers disclosed elsewhere here. Similarly, the semiconductor device-embedded silk leathers described herein can be made from, comprise, wholly include, or include features from the liquid compositions, whipped silk creams, silk meringues, compressed silk meringues, hot-pressed silk meringues, or methods disclosed elsewhere herein.

### Haptic Silk Leather

The present disclosure provides a haptic silk leather having a haptic switch embedded therein. The haptic silk leather can comprise, consist essentially of, or consist of any of the silk meringues described herein. The haptic switch or a second haptic switch may be embedded at a surface of the silk leather. The haptic switch or a third haptic switch may be embedded within the compressed silk meringue or the hot-pressed silk meringue. The haptic switch or a fourth haptic switch may be embedded between the first fabric layer and the compressed silk meringue or the hot-pressed silk meringue. In aspects, the haptic silk further comprises a power supply, as described elsewhere herein, coupled to the haptic switch. In aspects, the haptic switch may be in communication with one or more electronic components or semiconductor devices in the silk leather.

For the avoidance of doubt, the haptic silk leathers described herein can wholly include or include features of the silk leathers disclosed elsewhere here. Similarly, the haptic silk leathers described herein can be made from, comprise, wholly include, or include features from the liquid compositions, whipped silk creams, silk meringues, compressed silk meringues, hot-pressed silk meringues, or methods disclosed elsewhere herein.

### Tanned Silk Leather

The present disclosure provides a tanned silk leather. The tanned silk leather can comprise, consist essentially of, or consist of any of the silk meringues described herein. The tanned silk leather may have a bulk volume of a compressed silk meringue or hot-compressed silk meringue and a surface layer of the compressed silk meringue or hot-pressed silk meringue. The surface layer may be formed from the same chemical composition as the bulk volume but includes at least one differing structural, mechanical, or chemical feature relative to the bulk volume. In an aspect, the surface layer includes a dye.

In an aspect, the surface layer comprises a material, such as a precursor material, that may mimic tanning products (e.g., absorb aniline/dyes). In some examples, the precursor reacts to form the surface layer. In aspects, the surface layer may be modified/re-shaped relative to the bulk volume, such as by surface patterning, to provide a material difference to the surface layer. Silk leathers subjected to processes akin to tanning (e.g., chemical treatment with aniline) may result in a relatively stiff material which may, for example, be relatively more processable for fashion industries.

For the avoidance of doubt, the tanned silk leathers described herein can wholly include or include features of the silk leathers disclosed elsewhere here. Similarly, the tanned silk leathers described herein can be made from, comprise, wholly include, or include features from the liquid compositions, whipped silk creams, silk meringues, compressed silk meringues, hot-pressed silk meringues, or methods disclosed elsewhere herein.

### Open Cell Silk Foam

The present disclosure provides an open-cell silk foam. The inventors discovered that controlling the whipping during the making of the silk cream can control the nature of the pores that are created in eventual silk foams/meringues. If the whipping falls within a given window of whipping (i.e., exceeds a first whipping threshold, but does not exceed a second whipping threshold), an open-cell pore structure is formed in the whipped silk cream, resulting in an open-cell silk foam/meringue when baked. The open cell foams are generally lighter, more white and reflective, and more permeable to organic solvents. In some embodiments, open cell foams may be preferable for fragrance release or other applications that include loading of the baked foam. Open cell foams may be useful for sensor applications where sensors have to interact with the environment, such as gas, humidity or pH sensors.

### Closed Cell Silk Foam

The present disclosure provides a closed-cell silk foam. The inventors discovered that controlling the whipping during the making of the silk cream can control the nature of the pores that are created in eventual silk foams/meringues. If the whipping falls outside a given window of whipping (i.e., does not exceed a first whipping threshold or does exceed a second, higher whipping threshold), a closed-cell pore structure is formed in the whipped silk cream, resulting in a closed-cell silk foam/meringue when baked. A closed cell morphology may be useful for applications in which an element is added to the foam during whipping and it is desired to preserve the element (e.g., living organisms or mechanical/thermal sensors).

### Multi-Valent Ions

The present disclosure provides compositions that include multi-valent ions. The inventors discovered that addition of multi-valent ions alters the mechanical properties of the leather resulting in greater mechanical strength. Addition of multi-valent ions also improves homogeneity of the foam after whipping which is evidenced by fewer clots in the whipped silk creams. Dissolution of alginate is also facilitated, which reduces yellowing of the silk foams. Without wishing to be bound by any particular theory, it is believed that addition of multi-valent ions crosslinks the alginate present in the silk compositions.

Multi-valent ions may include cupric ions, calcium salts, chloride salts, or the like. Cupric ions may include CuCl₂. Calcium salts may include Ca(OH)₂, CaCO₃, and/or CaCl₂. Chloride salts may include CuCl₂, CaCl₂, or ZnCl₂.

In some embodiments, adding CaCl₂ before whipping may reduce clot formation. There may be a decrease in overrun dependent on multi-valent ion concentration. Addition of multi-valent ions may influence the material's appearance, including color and feeling to the touch, as well as mechanical properties. Addition of multi-valent ions may result in swelling of up to 100%, up to 200%, up to 300%, or higher. Swelling may increase with increasing multi-valent ion concentration. Swelling of silk leathers with multi-valent ions may persist after drying. Addition of multi-valent ions may decrease mass loss after water immersion and/or reduce foam dissolution in water. Mass loss may decrease after water immersion proportional to multi-valent ion concentration. Addition of multi-valent ions may induce formation of alginate films on the bottom of the foam.

In some embodiments, multi-valent ions may be added in 10 mmol to 250 mmol of salt per gram of added alginate or 10 mmol to 500 mmol of salt per gram of added alginate.

### High Alginate

The present disclosure provides formulations with high ratios of alginate relative to the usual 20:20:60 alginate-based ratio. The inventors discovered that adjusting the silk fibroin:alginate ratio changed both the mechanical properties and swelling behavior of the corresponding foams and leathers in water. While high alginate foams collapsed after baking, they also demonstrated increased sturdiness. The high SF ratio foams were smoother and softer to the touch which could lead to increased surface damage.

### Types of Alginate

The present disclosure provides different viscosities of alginates for formulations. High viscosity alginates may have a viscosity above 500 mPa*s. For example, high viscosity alginates may have a viscosity of at least 500 mPa*s, at least 700 mPa*s, at least 900 mPa*s, at least 1100 mPa*s, or at least 1250 mPa*s. Low viscosity alginates may have a viscosity below 500 mPa*s. For example, low viscosity alginates may have a viscosity of at most 500 mPa*s, at most 400 mPa*s, at most 300 mPa*s, at most 200 mPa*s, at most 100 mPa*s, at most 50 mPa*s, or at most 30 mPa*s. The alginates may be modified with propylene glycol or other compounds or polymers.

### Whipping Time

The present disclosure provides a variety of different whipping times (Wts) in the processing of the liquid compositions described herein. Wt may be at least 2.5 min, at least 5 min, at least 7.5 min, at least 10 min, at least 12.5 min, at least 15 min, at least 17.5 min, at least 20 min, at least 22.5 min, at least 25 min, or at least 30 min.

pH

The present disclosure provides different pHs of liquid compositions for whipping. For example, the pH may be at least 4, at least 8, at least 10, or at least 11, or at most 11, at most 9, at most 8, or at most 5.

### Blended Polysaccharides

The present disclosure provides for a blend of polysaccharides to be used in the compositions described herein. In some cases, the polysaccharides may be thickening agents as thickening may be a beneficial property of the silk creams.

In some aspects, a blend of alginate and xanthan gum can be used as the polysaccharide. The alginate can be between 10% and 90% of the blend of alginate and xanthan gum, including, but not limited to, at least 10%, at least 30%, at least 50%, or at least 70%, and at most 80%, at most 60%, at most 40%, or at most 20%. The xanthan gum can be between 10% and 90% of the blend of alginate and xanthan gum. The xanthan gum can be at least 10%, including but not limited to, at least 30%, at least 50%, or at least 70%. The xanthan gum can be at most 80%, including but not limited to, at most 60%, at most 40%, or at most 20%.

In other aspects, a blend of alginate and locust bean gum can be used as the polysaccharide. The alginate can be between 10% and 90% of the blend of alginate and xanthan gum, including, but not limited to, at least 10%, at least 30%, at least 50%, or at least 70%, and at most 80%, at most 60%, at most 40%, or at most 20%. The locust bean gum can be between 10% and 90% of the blend of alginate and xanthan gum, including, but not limited to, at least 10%, at least 30%, at least 50%, or at least 70%, and at most 80%, at most 60%, at most 40%, or at most 20%.

### Surface Treatments

An objective of these treatments was to improve water resistance. One previously described approach involved dipping the leather in an ethanol (EtOH) solution containing shellac. Since silk, alginate, and xanthan gum are water-soluble but largely insoluble in EtOH and other organic solvents, several coating strategies utilized EtOH as a carrier for surface-modifying agents

The present disclosure provides for ionic surface treatments comprising water, a carrier solvent, and an ionic salt. In some cases, the ionic surface treatment comprises or consists of water and the ionic salt. The ionic salt may be a multivalent salt and/or may comprise a cation. Multivalent salts used may be CaCl₂), CuCl₂, FeCl₃, or similar salts. Concentrations of between 10 mg/mL and 100 mg/mL may be used to prepare the ionic surface treatment solutions. In some cases, the concentration may be at least 10 mg/mL, including but not limited to, at least 30 mg/mL, at least 50 mg/mL, at least 70 mg/mL, or at least 90 mg/mL. In some cases, the concentration may be at most 100 mg/mL, including but not limited to, at most 80 mg/mL, at most 60 mg/mL, at most 40 mg/mL, or at most 20 mg/mL. After application, the multivalent ion salts may diffuse to a depth between 100 μm and 200 μm in the treated silk leather. In some cases, the depth of diffusion may be at least 100 μm, including but not limited to, at least 120 μm, at least 140 μm, at least 160 μm, or at least 180 μm. In some cases, the depth of diffusion may be at most 200 μm, including but not limited to, at most 190 μm, at most 170 μm, at most 150 μm, at most 130 μm, or at most 110 μm. Increasing exposure time of the silk leather to the ionic surface treatment may not increase penetration depth. Exposure time off the silk leather to the ionic surface treatment of greater than 30 minutes may result in degradation of the silk leather.

In some aspects, the carrier solvent may be at least one of methanol, ethanol, propanol, isopropanol, acetone, dimethyl sulfoxide (DMSO), chloroform, or acetonitrile. The cation or multivalent ion may be at least one of Ca²⁺, Cu²⁺, Fe²⁺, or Fe³⁺. The ionic surface treatment may be applied by at least one of dipping, soaking, brushing, rinsing, immersing, spraying, or dripping. The ionic treatment may be applied at least one time, at least two times, or at least three times. The ionic surface treatment may be Ajisawa solution, which may also be referred to as Ajisawa reagent. A hydrophobicity of the silk leather may be improved relative to a comparison hydrophobicity for a comparison silk leather that lacks the ionic surface treatment.

In some aspects, an ionic-treated silk leather has improved water resistance. The ionic-treated silk leather has at least a portion of at least one surface treated with an ionic surface treatment. The surface treatment can include water, a carrier solvent, and a cation. The surface treatment can include water and a cation. The cation may be a multivalent ion.

In other aspects, a method of improving water resistance of silk leather with an ionic compound involves applying an ionic surface treatment to at least a portion of an untreated silk leather to form an ionic-treated silk leather. The ionic surface treatment can include water, a carrier solvent, and a cation. The ionic surface treatment can include water and a cation. The cation may be a multivalent ion.

In some aspects, a second portion of the ionic-treated silk leather may be treated with a polysaccharide solution after application of the ionic surface treatment to form polysaccharide-treated ionic-treated silk leathers. The polysaccharide may be an alginate, e.g., sodium alginate. The alginate solution may contain alginate in an amount by weight of between 0.1% and 10%. In some cases, the alginate solution may contain alginate in an amount by weight of at least 0.1, including but not limited to, at least 0.5%, or at least 5%. In some cases, the alginate solution may contain alginate in an amount by weight of at most 10%, including but not limited to at most 3%, or at most 0.3%. After dipping the ionic-treated silk leather in the polysaccharide solution, a film may form on the polysaccharide-treated ionic-treated silk leather that may be peeled off, exfoliated, sloughed, or otherwise removed to form an exfoliated treated leather. Without wishing to be bound by any particular theory, it is believed that the film may serve as a sacrificial reactive layer on the silk leather. By removing the film, residual ions may be removed from the surface of the silk leather. Water absorption of polysaccharide-treated ionic-treated silk leathers may be up to 90% less than water absorption of a comparable ionic-treated silk leather that lacks the polysaccharide treating. Water absorption of the polysaccharide-treated ionic treated silk leather may be up to 10% less, including but not limited to, up to 30%, up to 50% less, or up to 70% less than water absorption of a comparable ionic-treated silk leather that lacks the polysaccharide treating.

The surface treatments described herein can be applied in a variety of ways, as would be understood by a person having ordinary skill in the art. In one case, the surface treatments can be applied by dipping a material into a solution. In some cases, the surface treatments can be applied by applying a solution onto a surface of a material. In some cases, the surface treatments can be applied by spraying a solution onto a surface of a material.

### Thermal Transition of Silk Materials

In sections herein describing thermal compression of silk-based leathers, the methods may also be applied to other silk materials, including but not limited to, silk foams, compressed silk foams, silk meringues, or compressed silk meringues. It should be appreciated that the thermal transition described herein can be achieved using thermal compression that is done in addition to, in concert with, or in place of any compression or thermal treatment involved in producing the silk-based leather itself. For example, many silk-based leathers include a compressed silk meringue or a hot-pressed silk meringue, and the thermal transitions described herein may be generally achieved following the compressing or hot-pressing within the process of making the silk-based leather. Thermal transition silk leathers or thermal transition silk materials may have a degree of transition which is correlated to the amount of material that undergoes the thermal transition. Materials with a partial degree of transition may have a portion that has transitioned and a separate portion that remains as the starting material. Materials with a full degree of transition may have only material that has transitioned and no starting material remaining. Materials that have undergone the at least partial thermal transition possess drastically different physical and mechanical properties compared to those that have not. Properties that may change include, but are not limited to, tactile feel, color, density, tensile strength, thermoplasticity, surface roughness, coefficient of friction, elastic compression. Young's modulus, hydrophobicity, or water resistance. The degree to which the properties change may be proportional to the degree of thermal transition.

In some cases, the composition of the thermal transition material can be the composition of one of the silk-based leathers described above, wherein gelatin is used as a replacement for the polysaccharide (e.g., xanthan gum and/or alginate).

The present disclosure provides for thermoplastic molding of silk-gelatin based leather materials, which may be referred to as thermopressing or thermal transitioning. Silk leathers may be compressed between 90 °C and 150 °C and 5 MPa and 15 MPa for durations ranging from 10 to 30 minutes. In some cases, compression may be performed at a temperature of at least 90 °C, including but not limited to, at least 110 °C, at least 130 °C, or at most 150 °C. In some cases, compression may be performed at a temperature of at most 140 °C, including but not limited to, at most 120 °C, or at most 100 °C. In some cases, compression may be performed at a pressure of at least 5 MPa, including but not limited to, at least 8 MPa, or at least 11 MPa. In some cases, compression may be performed at a pressure of at most 15 MPa, including but not limited to, at most 12 MPa, or at most 9 MPa. In some cases, compression may be performed for at least 10 minutes or at least 20 minutes. In some cases, compression may be performed for at most 25 minutes or at most 15 minutes. The compressed silk leathers may exhibit partial thermal transitions and slight increases in transparency. There may be regions of localized darkening. The localized darkening may indicate thermal degradation. Alginate-based foams may undergo thermal transitions better than xanthan gum-based foams. Alginate-based foams may display surface degradation before bulk fusion. This may be due to alginate's lower degradation temperature compared to silk fibroin. Xanthan-gum based foams may have better compressibility and lower resistance to deformation. Xanthan-gum based foams may show a more pronounced surface transition than alginate-based foams after thermopressing.

Compatibility with thermal fusion may be increased by adding gelatin and/or replacing a portion or all of the polysaccharide component of the silk leather with gelatin. Gelatin-based silk leathers may exhibit a more uniform and complete thermal transition. The thermopressed gelatin-based silk leather may exhibit more uniform and complete thermal transition and exhibit greater transparency and less thermal degradation than alginate-based silk leathers or xanthan-gum based silk leathers. Gelatin-based silk leathers may still exhibit homogeneity and transparency when organza is embedded within the foam. Using embossing grids may enable the creation of custom patterns. It may be possible to control the extent of thermal transition to create structures with a continuous outer layer of fully transitioned, transparent material surrounding areas that remain foamy, less dense, and opaque. Gelatin-based silk leathers that have undergone thermopressing may show strong adhesion to textiles, improved water stability, and enhanced mechanical properties. The gelatin-based silk leathers may also be more rigid and have a more plastic-like tactile feel. Thermopressed gelatin-based silk leathers may show less swelling after immersion in water than alginate-based silk leathers. Gelatin-based silk leather may have a tensile strength between 5 MPa and 10 MPa. In some cases, the tensile strength may be at least 5 MPa, including but not limited to, at least 7 MPa, or at least 9 MPa. In some cases, the tensile strength may be at most 10 MPa, at most 8 MPa, or at most 6 MPa.

In other aspects, a method for inducing thermal transition in a silk leather may include applying an elevated pressure for a pressure applying length of time and an elevated temperature for a temperature applying length of time to the silk leather to form a thermal transition silk leather. Applying the elevated pressure and the elevated temperature induces at least partial thermal transition. The silk leather includes gelatin. Applying the elevated temperature and the elevated pressure may be simultaneous or sequential. The silk leather may further include at least one of a polysaccharide or a glycerol. The thermal transition silk leather may have a higher degree of transparency than the silk leather. The elevated pressure may be between 1 MPa and 30 MPa. In some cases, the elevated pressure may be at least 1 MPa, including but not limited to, at least 5 MPa, at least 15 MPa, or at least 25 MPa. In some cases, the elevated pressure may be at most 30 MPa, including but not limited to, at most 20 MPa, or at most 10 MPa.

The elevated temperature may be between 80 °C and a thermal decomposition temperature. A skilled artisan will recognize that thermal decomposition is a function of thermal dose, which is a combination of temperature reached and application time. At least one of the temperature applying length of time or the pressure applying length of time may be between 5 minutes and 30 minutes. In some cases, the temperature applying length of time or the pressure applying length of time may be at least 5 minutes, including but not limited to, at least 15 minutes or at least 25 minutes. In some cases, the temperature applying length of time or the pressure applying length of time may be at most 30 minutes, at most 20 minutes, or at most 10 minutes. Applying the elevated pressure and the elevated temperature may induce a total degree of transition. A skilled artisan will recognize that a combination of higher and lower temperatures, pressures, and applying times than described herein could be used to achieve the same outcome of thermal transition, e.g., a lower temperature and higher pressure or a higher temperature and lower pressure. The temperature applying time and pressure applying time may be the same or different.

In some aspects, a thermal transition silk leather is made by the methods described herein. The thermal transition silk leather may have a tensile strength of between 5 MPa and 15 MPa. In some cases, the tensile strength may be at least 5 MPa, including but not limited to, at least 8 MPa or at least 11 MPa. In some cases, the tensile strength may be at most 15 MPa, including but not limited to, at most 12 MPa, at most 9 MPa, or at most 6 MPa. A surface of the thermal transition silk leather may be less darkened relative to a comparison surface of a comparison thermal transition silk leather that lacks the gelatin following the applying the elevated temperature and the applying the elevated pressure. A thermoplastic character of the thermal transition silk leather may be greater relative to a comparison thermoplastic character for a comparison thermal transition silk leather that lacks the gelatin. A tactile feel of the thermal transition silk leather may be more similar to natural leather relative to a comparison tactile feel for a comparison thermal transition silk leather that contains an equal proportion of xanthan gum in place of the gelatin. A tactile feel of the thermal transition silk leather may have a tactile feel evaluated by a sensory panel as being more similar to natural leather than a comparison thermal transition silk leather that contains an equal proportion of xanthan gum in place of the gelatin.

A surface roughness of the thermal transition silk leather or thermal transition silk material as evaluated by at least one of atomic force microscopy (AFM) or profilometry may be more similar to a natural leather or natural material surface roughness than a comparison thermal transition silk leather or thermal transition silk material surface roughness that contains an equal proportion of xanthan gum in place of the gelatin. A coefficient of friction of the thermal transition silk leather or thermal transition silk material as measured by a tribometer may be more similar to a natural leather surface or a natural material coefficient of friction than a comparison thermal transition silk leather or thermal transition silk material coefficient of friction that contains an equal proportion of xanthan gum in place of the gelatin. An elastic compression of the thermal transition silk leather or thermal transition silk material may be more similar to a natural leather or natural material elastic compression than a comparison thermal transition silk leather or thermal transition silk material elastic compression that contains an equal proportion of xanthan gum in place of the gelatin. A tactile feel of the thermal transition silk leather or thermal transition silk material evaluated by a statistically significant sample of human subjects using a sensory discrimination test may be more similar to natural leather or a natural material than a comparison thermal transition silk leather or thermal transition silk material that contains an equal proportion of xanthan gum in place of the gelatin. The sensory discrimination test may be a triangle test, optionally be ISO 4120. A surface roughness of the thermal transition silk leather or thermal transition silk material as evaluated by at least one of atomic force microscopy (AFM) or profilometry may be statistically similar to a natural leather or a natural material surface roughness. A coefficient of friction of the thermal transition silk leather or thermal transition silk material as measured by a tribometer may be statistically similar to a natural leather or natural material coefficient of friction. An elastic compression of the thermal transition silk leather or thermal transition silk material may be statistically similar to a natural leather or natural material elastic compression. The thermal transition silk leather or thermal transition silk material may have a tactile feel as evaluated by a statistically significant sample of human subjects as using a sensory discrimination test as being imperceptibly different from a tactile feel of a natural leather or a natural material. The sensory discrimination test may be a triangle test, optionally be ISO 4120.

In other aspects, a silk leather is a layered structure including a first thermal transition silk leather and a second material layer disposed adjacent to the first thermal transition silk leather layer, wherein the first thermal transition silk leather layer has been treated with a thermal transition treatment. The silk leather may include gelatin. In some cases, an adhesion strength of the silk leather as measured by a T-Peel test between the first thermal transition layer and the second material layer is at least 20% greater than a comparison adhesion strength between a comparison fabric layer and a comparison second material layer, including but not limited to, at least 30% greater, at least 40% greater, at least 50% greater, at least 60% greater, at least 80% greater, at least 100% greater, at least 120% greater, at least 140% greater, at least 160% greater, at least 180% greater, or at least 200% greater than a comparison adhesion strength between a comparison fabric layer and a comparison second material layer. The comparison first layer lacks a thermal transition treatment of the first thermal transition silk leather layer but is otherwise identical to the first thermal transition silk leather and the comparison second material layer is otherwise identical to the second material layer. The thermal transition treatment may include applying an elevated pressure for a pressure applying length of time and an elevated temperature for a temperature applying length of time to the silk leather. In some cases, an adhesion strength as measured by a T-Peel test between the first thermal transition layer and the second material layer is at least 15 Newtons/meter (N/m), including but not limited to, at least 17 N/m, at least 20 N/m, at least 22 N/m, at least 25 N/m, at least 30 N/m, at least 40 N/m, at least 50 N/m, at least 60 N/m, or at least 70 N/m. The second material layer may include at least one of a cotton fabric, a silk fabric, a synthetic fabric, a linen fabric, an organza fabric, or a hydrophilic fabric.

In some aspects, a method of inducing patterned thermal transition in a silk leather includes applying an elevated pressure for a pressure applying length of time and an elevated temperature for a temperature applying length of time to the silk leather using a patterned stamp to form a patterned thermal transition silk leather that has a degree of transition. Applying the elevated pressure and the elevated temperature induces at least partial thermal transition. The silk leather can include gelatin. The patterned stamp may include at least a first selection of stamp locations that contacts a first selection of silk leather locations and a second selection of stamp locations that contacts a second selection of silk leather locations. The first selection of silk leather locations may have a degree of compression that is different from the degree of compression of the second selection of silk leather locations. The first selection of stamp locations may have a different height than the second selection of stamp locations. In some cases, applying the elevated temperature and applying the elevated pressure may be simultaneous. In some cases, applying the elevated temperature may be performed first and applying the elevated pressure may be performed second. In some cases, applying the elevated pressure may be performed first and applying the elevated temperature may be performed second. The patterned thermal transition silk leather may have a degree of transition which is correlated to the amount of material that undergoes the thermal transition. Materials with a partial degree of transition may have a portion that has transitioned and a separate portion that remains as the starting material. Materials with a full degree of transition may have only material that has transitioned and no starting material remaining. Applying the elevated pressure and applying the elevated temperature may induce a total degree of transition. A skilled artisan will recognize that a combination of higher and lower temperatures, pressures, and applying times than described herein could be used to achieve the same outcome of thermal transition, e.g., a lower temperature and higher pressure or a higher temperature and lower pressure. The temperature applying time and the pressure applying time may be the same or different.

End uses of thermal transition materials include products that have at least some of the features of the patterned stamp. The products may have a negative imprint of the patterned stamp on at least one surface. The pattern may be at least one of functional or decorative. More than one pattern may be used, and the different patterns may fully overlap, partially overlap, or not overlap. The patterns may have varying depths, widths, and lengths. The patterned stamps may be used one or more times. The end use products may be composed partially of or entirely of the thermal transition materials. More than one thermal transition material may be in the end use products. Patterning products may modify at least one of aesthetic, mechanical, or optical properties of the products as described herein. Patterning may also be used to create separate regions with predetermined patterns for functional applications. Moreover, since the patterning process acts as a mask during the thermal transition, patterning enables spatial control over material density, which allows the formation of alternating high- and low-density regions. Separate patterned regions and spatial control over density may impart beneficial properties for sensing, protecting, decorating, or other functional applications of products.

It should be appreciated that there are a host of end uses for the materials described herein. Examples include, but are not limited to, bio-responsive seating, body monitors, leather bracelets as health indicators, enzymatic bracelets, scented bracelets, sensing sofas, fluorescent foams, microelectronic heat dissipators, fuel cell electrode matrices, food flavoring, water purifiers, pool purifiers, ocean oil capture, an ultralight insulator alternative (e.g., alternative to goose down), a leather-like impact monitor, gas sensing personal protective equipment (PPE), and the like.

Unless otherwise specified or indicated by context, the terms “a”, “an”, and “the” mean “one or more.” For example, “a molecule” should be interpreted to mean “one or more molecules”.

As used herein, “about”, “approximately”, “substantially”, and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### EXAMPLES

### Example 1: Ionic Surface Treatment

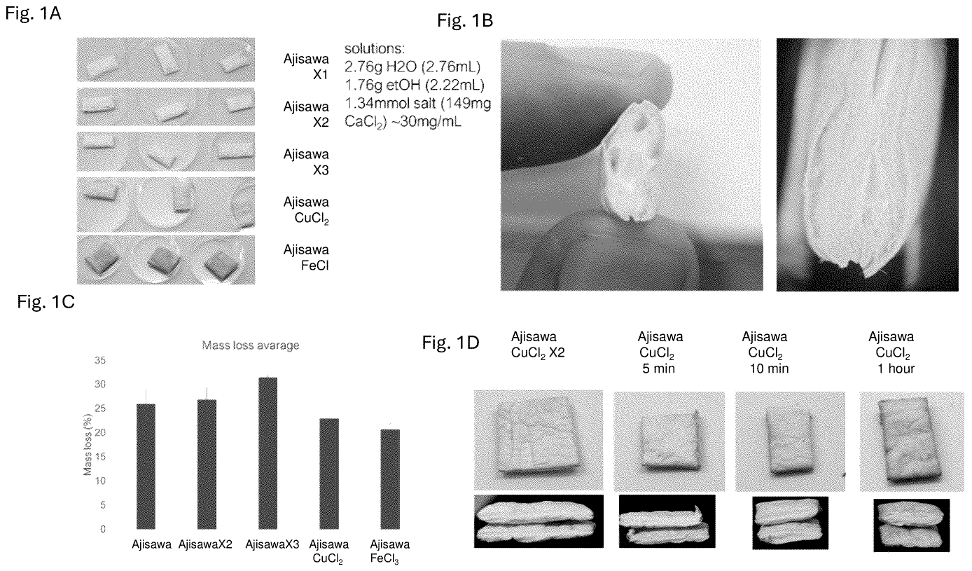

FIG. 1 describes a coating protocol using modified Ajisawa solutions, also referred to as Ajisawa reagents. Originally developed for dissolving silk fibers, Ajisawa solution is a water-EtOH mixture containing 2.76 g of water, 1.76 g of EtOH, and 149 mg of CaCl₂). Given the known ability of Ca²⁺ to crosslink alginate, this solution was tested as a surface treatment to assess whether it could improve water resistance. Different concentrations of CaCl₂) (30 mg/mL, 60 mg/mL, 90 mg/mL) were evaluated, along with alternative metal salts such as CuCl₂ and FeCl₃. These latter salts, while binding less strongly than CaCl₂), were chosen for their color, facilitating visualization of penetration depth within the material.

Following brief dipping in these solutions, cross-sectional imaging of CuCl₂-treated samples revealed diffusion of the salt to a depth of 100 μm-200 μm (FIG. 1A, FIG. 1B). However, subsequent water immersion tests demonstrated no significant improvement in swelling resistance or mass loss reduction after drying (FIG. 1C). Further tests with CuCl₂, varying its concentration and exposure time, did not alter penetration depth or material response to water exposure (FIG. 1D). Prolonged immersion in Ajisawa solution (>30 minutes) resulted in visual degradation of the material. Across all samples tested, no substantial improvement in water resistance was observed, indicating that this surface treatment does not provide effective protection against moisture-related degradation.

### Example 2: Evaluation of Thermoplastic Molding of Silk-Gelatin Based Leather Materials

Silk-based leather foams composed of silk fibroin (SF, 20%), alginate or xanthan gum (20%), and glycerol (60%) were subjected to thermal compression at 120 °C and 10 MPa for durations ranging from 10 to 30 minutes. The processed materials exhibited partial thermal transitions, with a slight increase in transparency. Results were more favorable for xanthan gum-based foams, although in both cases, localized darkening was observed-indicative of thermal degradation.

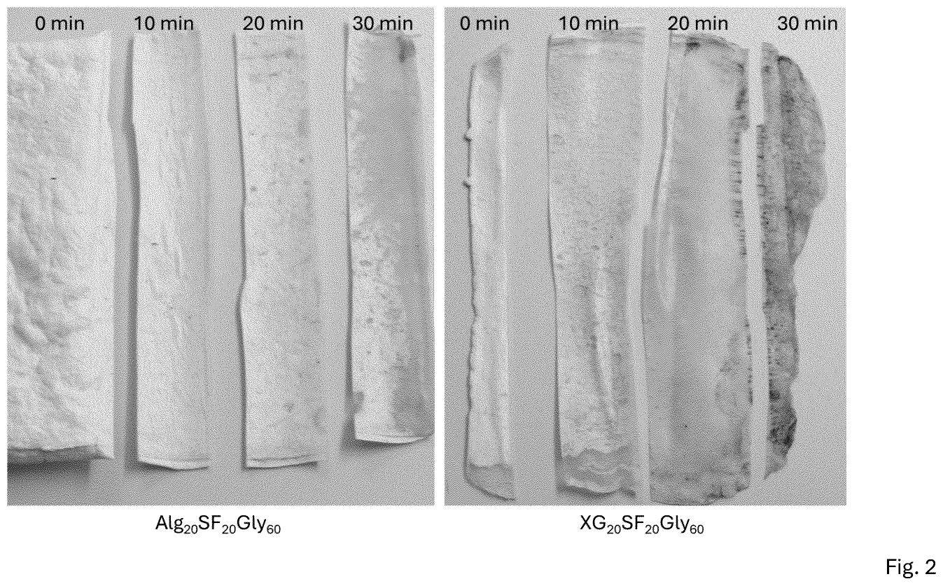

For alginate-based foams, surface degradation occurred before complete bulk fusion could take place, resulting in a white, opaque, and spongy interior. This is likely due to alginate's lower thermal degradation threshold (200 °C-250 °C) compared to silk fibroin (250 °C-300 °C) (FIG. 2).

Xanthan gum, which offers better compressibility and lower resistance to deformation, showed a more pronounced surface transition. After 10 minutes, the foam retained a white, spongy core, while after 20 minutes, the transition extended more uniformly, resulting in a fairly transparent bulk. By 30 minutes, signs of thermal degradation began to appear (FIG. 2).

To enhance compatibility with thermal fusion, the polysaccharide component was replaced with gelatin for the following reasons: i) gelatin is a protein and may facilitate better molecular interactions with silk fibroin; ii) it has been successfully used as a thickening agent in related processes; and iii) it shares chemical and structural similarities with natural leather, being derived from hydrolyzed collagen.

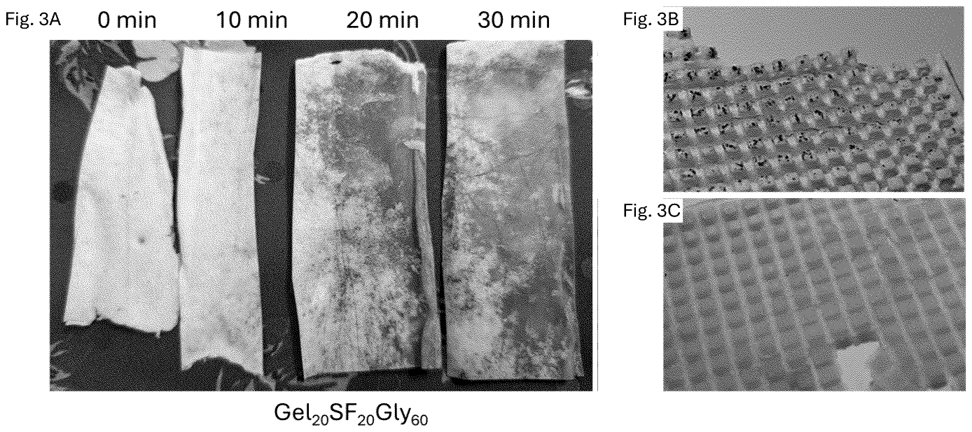

When subjected to the same thermopressing conditions, gelatin-based leathers exhibited a more uniform and complete thermal transition. The resulting material was more homogeneous and showed improved mechanical integrity. As shown in FIG. 3A, the gelatin-based composition underwent a consistent thermal transition, with greater transparency and less thermal degradation compared to samples containing polysaccharides.

To further highlight the differences between the two formulations, thermopressing was also conducted with a plastic canvas placed above and below the material. In the case of the alginate-based sample (FIG. 3B), the upper surface showed visible signs of burning, while the gelatin-based sample (FIG. 3C) exhibited a homogeneous transition throughout the entire thickness of the material.

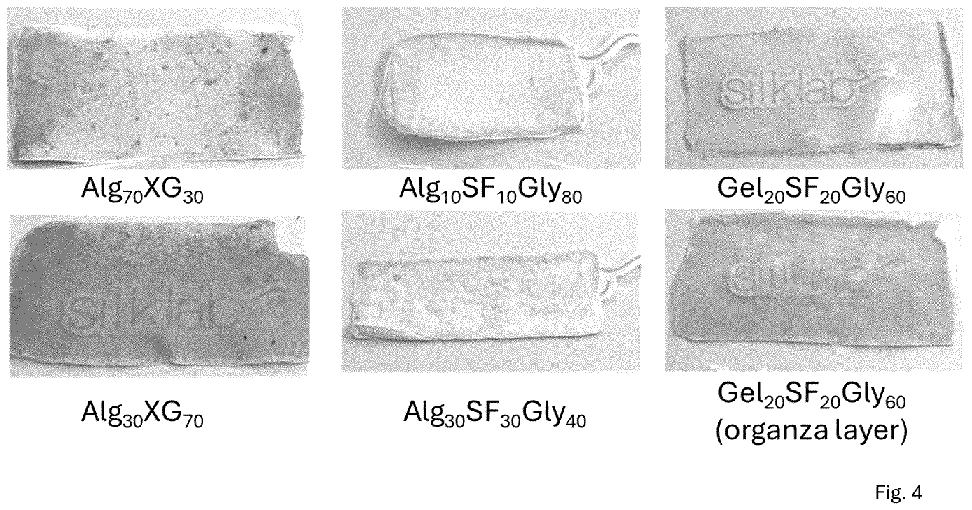

Additional experiments were conducted to investigate how the composition of the leather influences the thermal transition. Various combinations of alginate (Alg) and xanthan gum (XG) were subjected to thermal pressing (FIG. 4, left), revealing improved transparency in compositions with higher XG content. The effect of different glycerol concentrations in an alginate-based composition was also evaluated (FIG. 4, center). However, even with up to 80% plasticizer, the leather did not exhibit transparency. In contrast, replacing the polysaccharide with gelatin yielded the best results in terms of homogeneity and transparency (FIG. 4, right), even when a layer of silk fabric (organza) was embedded within the foam.

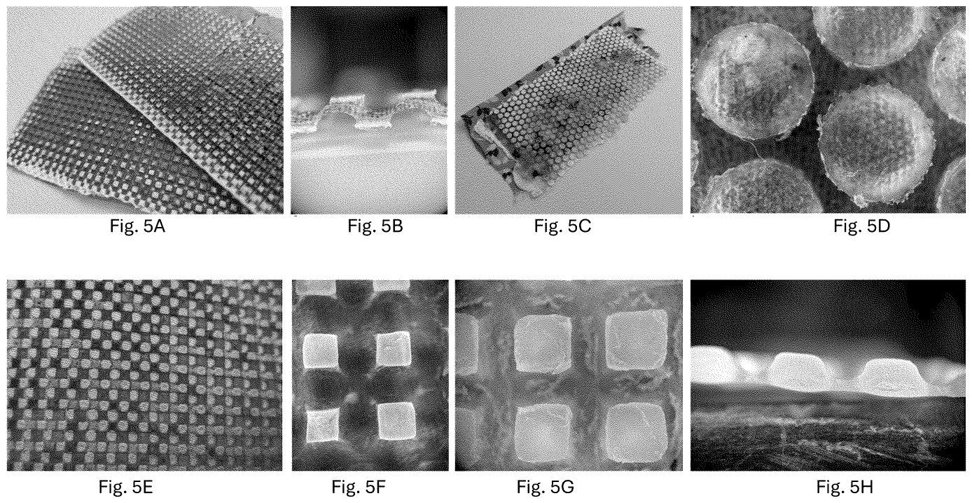

By leveraging the thermal transition process, it is possible to introduce new aesthetic and mechanical properties to silk-based leather composites. FIG. 5 illustrates some of these potential applications. In FIG. 5A, two different fabrics were sandwiched between layers of silk-gelatin foam and compressed using a plastic canvas with square-shaped perforations to create a patterned structure. Within the perforations, reduced pressure during compression led to a localized thermal transition, embedding the textile layer in a transparent and wavy matrix, as shown in the cross-section in FIG. 5B. The square regions, by contrast, retained a white, porous, foamy appearance (FIG. 5F).

From an aesthetic standpoint, this process also modifies the transparency of the material, enabling the creation of custom patterns using embossing grids (FIG. 5E). Various patterns and geometries can be produced, each imparting unique flexibility and tactile properties to the composite (FIG. 5C and FIG. 5D). Furthermore, it is theoretically possible to control the extent of thermal transition to create structures with a continuous outer layer of fully transitioned, transparent material surrounding areas that remain foamy, less dense, and opaque (FIG. 5G and FIG. 5H).

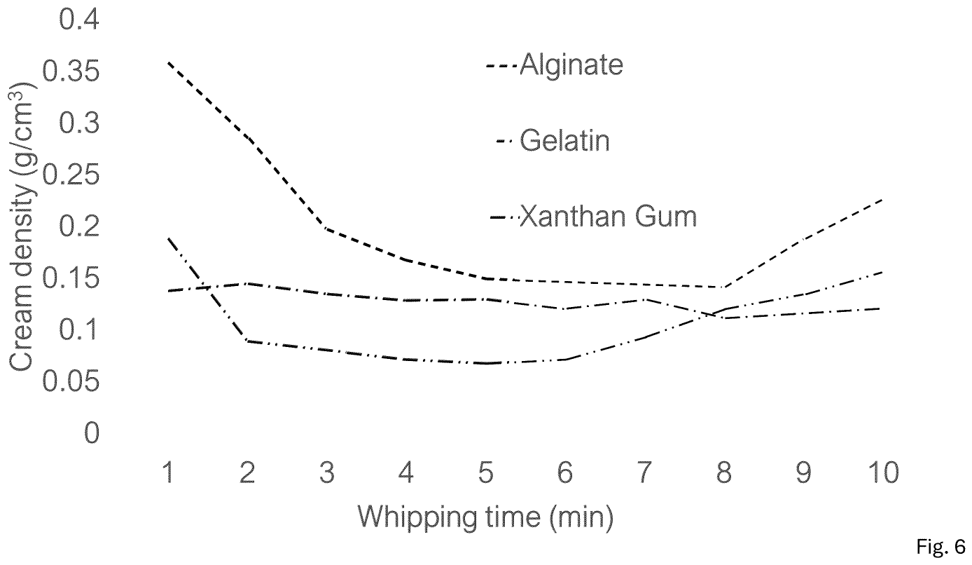

Cream densities for SF₂₀:Gel₂₀:Gly₆₀ showed minimal variation across different whipping times, indicating limited air incorporation compared to alginate- or xanthan gum-based foams as shown in FIG. 6. The aesthetic quality of the foams was generally inferior to what was achievable with other polysaccharides, and the structures often appeared collapsed and inhomogenous after the baking process.

However, following the thermal transition, the composite material offers several advantages over polysaccharide-based leathers, particularly when envisioned as an artificial leather. The key benefits of using gelatin-based formulations include strong adhesion to textiles, improved water stability, and enhanced mechanical properties.

Gelatin-based foams exhibit strong bonding with textile substrates, significantly reducing the common issue of delamination seen in foams based on polysaccharides. This enhanced mechanical integration comes with a trade-off—an increase in rigidity and a more plastic-like tactile feel.

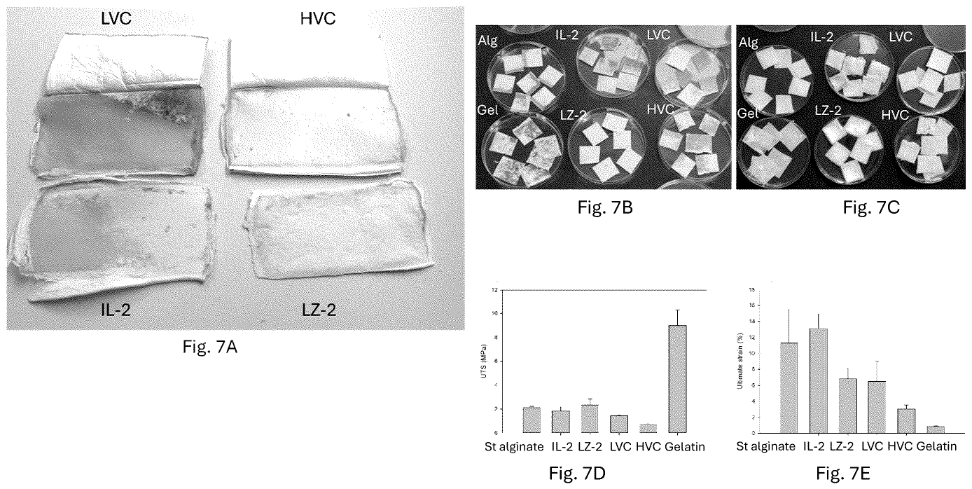

Water resistance was evaluated using various alginates (LVC, IL-2, HVC, and LZ-2 from KIMICA®). After thermopressing, low-viscosity alginates resulted in more transparent foams, while high-viscosity variants remained opaque. Upon 8-hour immersion in water, alginate-based samples displayed extensive swelling and structural disintegration. In contrast, gelatin-based samples showed minimal swelling and preserved both flexibility and mechanical integrity as shown in FIGS. 7A, 7B, and 7C.

Gelatin-based leather achieved the highest tensile strength at 8.5 MPa. Alginate-based leathers exhibited lower strengths ranging from 1 MPa to 2 MPa, with propylene glycol alginate variants performing slightly worse. In terms of elongation, alginates like Sigma and IL-2 reached strain values around 12%, while gelatin remained more brittle, with a strain of approximately 1% (FIG. 7D and FIG. 7E).

### Example 3: Thermal Transition of Silk Materials

To evaluate the applicability of thermoplastic molding to the silk-based leather materials described in this disclosure, a series of thermopressing experiments were performed. The present formulation includes additional components beyond silk fibroin, such as polysaccharides (Ps) and glycerol (Gly), which may interfere with the thermal fusion process.

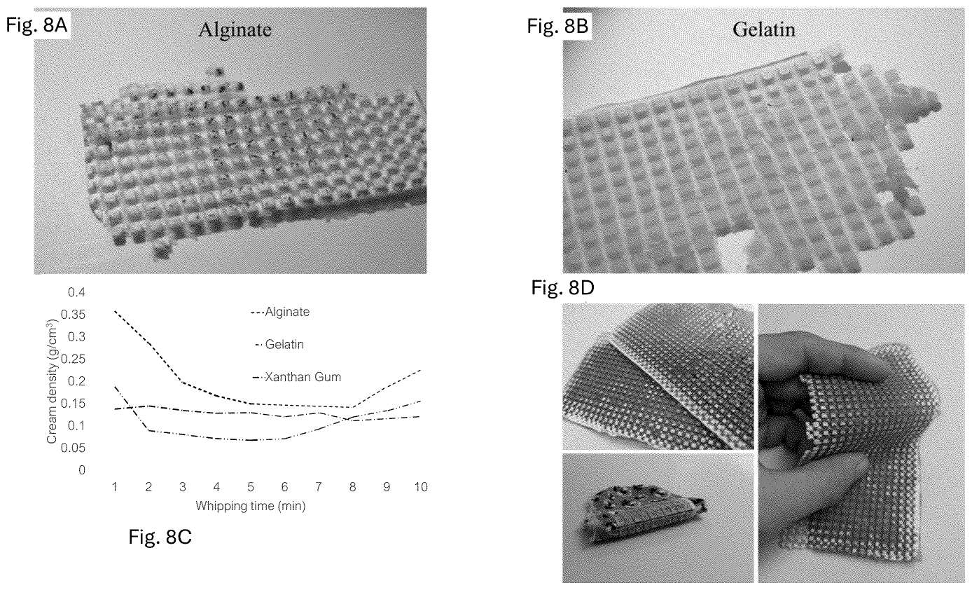

As shown in FIG. 8A, an alginate-based leather was subjected to compression molding at 10 MPa and 120 °C for 20 minutes. The resulting material displayed only a partial thermal transition, with the surface darkening due to localized degradation while the core remained white and spongy. The degradation temperature of alginate (200 °C-250 °C) is slightly lower than that of silk fibroin (250 °C-300 °C), which may explain this behavior.

To enhance compatibility with thermal fusion, gelatin was introduced as a replacement for alginate. Gelatin was selected because: 1. It is commonly used as a thickening agent; 2. Unlike polysaccharides, gelatin is a protein, potentially improving interactions with silk fibroin, particularly during thermal fusion; and 3. It is derived from hydrolyzed collagen, one of the primary components of natural leather, which may contribute to desirable mechanical and aesthetic properties.

As depicted in FIG. 8B, when a gelatin-based leather underwent the same thermopressing process, the thermal transition occurred more uniformly throughout the material's thickness, resulting in a more homogeneous transformation. FIG. 8C presents density values against whipping time for gelatin-based formulations, showing minimal variation, indicating reduced air incorporation compared to polysaccharide-based compositions. This behavior also leads to softer foams that tend to collapse after baking.

Additionally, FIG. 8D demonstrates that the thermal pressing process can be applied together with textiles, producing composite materials. A common issue with silk-leather composites containing a foamy layer is delamination from the textile substrate. However, when subjected to thermal transition, adhesion to the textile is significantly enhanced. While the process improves mechanical integration, it also alters the material's appearance and tactile properties, making it feel more rigid or plastic-like while maintaining some degree of flexibility.

### Example 4: Post-Treatment of Silk Leather

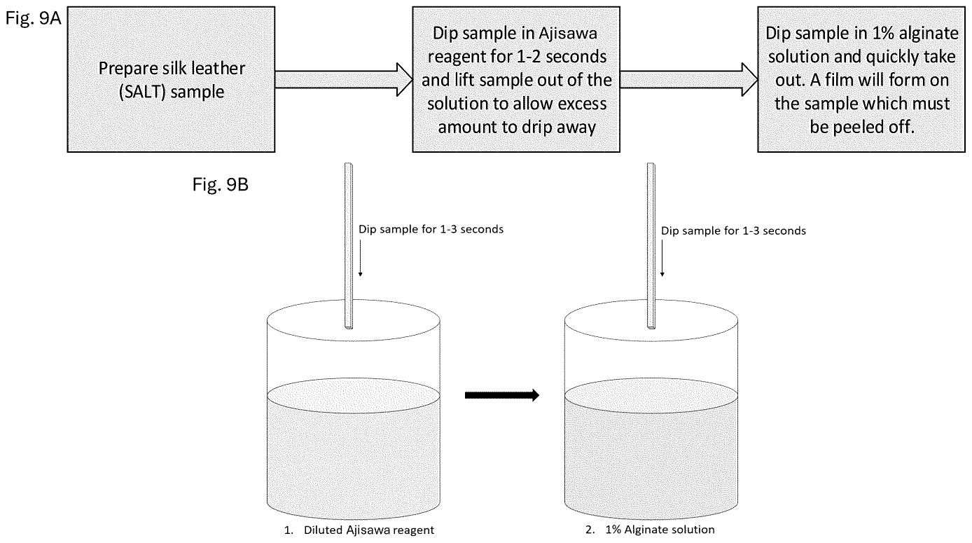

Silk leathers with textiles can be quite sensitive to moisture and water damage. When silk leathers come into contact with water, they may start dissolving. To counteract this problem, silk leathers were treated by dipping into Ajisawa solutions followed by dipping into 10 alginate solutions as outlined in FIG. 9A and FIG. 9B to form alginate-treated ionic-treated silk leathers. The Ajisawa reagent is based on the following formulation: 4068 g CaCl₂, 2548 g ethanol, and 2988 g of deionized water. The 1% alginate solution is made by adding 1% alginate into DI water and using an immersion mixer to blend the mixture into a gel. The immersion mixer is used to mix for about 1-2 minutes depending on the amount of the mix. As a result of the alginate treatment, a film formed on the sample that was peeled off.

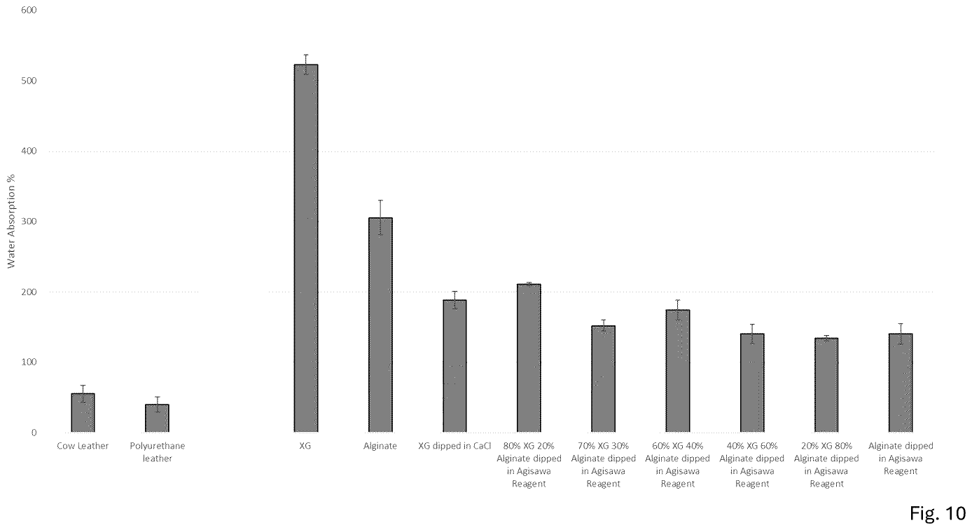

FIG. 10 shows the amount of water absorption of various leathers treated with this protocol. Results comparing characteristics of leathers with various treatments are shown in Table 1.

TABLE 1

| | | | Stitch | | Single and |
|---|---|---|---|---|---|
| | Polysaccharide | Post | Resistance | Distention | double edge |
| | used | treatment | (N/mm) | (mm) | tear (N) |
| 1 | Alginate | Annealed | 1 (longitudinal) | 8.7 | 4.4 (single edge) |
| | | 120 °C/1 hr | 2 (transversal) | | 11.1 (double edge) |
| 2 | Alginate | Annealed | 5.5 (longitudinal) | 8.2 | 16.8 (single edge) |
| | | 120 °C/1 hr | 7 (transversal) | | 53.6 (double edge) |
| 3 | Alginate | Annealed | 2 (longitudinal) | 8.4 | 3.2 (single edge) |
| | | 120 °C/1 hr | 0.5 (transversal) | | 9.05 (double edge) |
| 4 | Alginate | Dipped in | 4.5 (longitudinal) | 7.7 | 14.4 (single edge) |
| | | Ajisawa | 6.5 (transversal) | | 42.9 (double edge) |
| 5 | 80% Alginate | No treatment | 2.5 (longitudinal) | 9.2 | 6 (single edge) |
| | 20% Xanthan Gum | | 1.5 (transversal) | | 14 (double edge) |
| 6 | 80% Alginate | Dipped in | 2.5 (longitudinal) | 9.1 | 4.2 (single edge) |
| | 20% Xanthan Gum | Ajisawa | 2 (transversal) | | 10.2 (double edge) |
| 7 | 80% Alginate | Annealed | 1 (longitudinal) | 8.3 | 5.4 (single edge) |
| | 20% Xanthan Gum | 120 °C/1 hr | 2 (transversal) | | 13.4 (double edge) |

| | | | Flex | Abrasion | Abrasion | Flex |
|---|---|---|---|---|---|---|
| | Tensile | | Resistance | Resistance | Resistance | Resistance |
| | strength | Elongation | in Dry | in Dry | in wet | in wet |
| | (N/mm²) | (%) | condition | Conditions | Conditions | condition |
| 1 | 3.8 | 28 | 50 | 51.2 | Not | Failed |
| | | | | | determined | |
| 2 | 8.2 | 19 | 1 | 6.4 | 940 - | 1000 |
| | | | | | Complete | |
| | | | | | removal | |
| 3 | 3.2 | 27 | 100 | 2 | Not | Failed |
| | | | | | determined | |
| 4 | 12 | 20 | 10 | 51.2 (failed | 400 | 5000 |
| | | | | one of the | | |
| | | | | tests) | | |
| 5 | 4.4 | 28 | 20 | 51.2 (failed | Not | Failed |
| | | | | one of the | determined | |
| | | | | tests) | | |
| 6 | 4.4 | 35 | 2.5 | 51.2 | Not | Not tested |
| | | | | | determined | |
| 7 | 3.8 | 30 | 5 | 51.2 (failed | Not | Failed |
| | | | | one of the | determined | |
| | | | | tests) | | |

### EQUIVALENTS AND SCOPE

The recitation of a listing of elements in any definition of a variable herein includes definitions of that variable as any single element or combinations (or subcombinations) of listed elements. The recitation of an embodiment herein includes that embodiment as any single embodiment or in combination with any other embodiments or portions thereof. Those skilled in the art will recognize or be able to ascertain using no more than routine experimentation, many equivalents to the specific embodiments of the invention described herein.

The scope of the present invention is not intended to be limited to the above Description, but rather is as set forth in the following claims:

1. An ionic-treated silk leather with improved water resistance, the ionic-treated silk leather having at least a portion of at least one surface treated with an ionic surface treatment, wherein the ionic surface treatment comprises:
water, a cation, and optionally a carrier solvent.

2. The ionic-treated silk leather of claim 1, wherein the ionic surface treatment comprises the water, the carrier solvent, and the cation.

3. The ionic-treated silk leather of claim 1, wherein the ionic surface treatment consists of the water and the cation.

4. A polysaccharide-treated ionic-treated silk leather comprising the ionic-treated silk leather of claim 1, wherein a second portion of the at least one surface treated with the ionic surface treatment is treated with a polysaccharide surface treatment, wherein the polysaccharide surface treatment comprises a polysaccharide and water, wherein the polysaccharide is optionally an alginate.

5. An exfoliated treated leather comprising the polysaccharide-treated ionic-treated silk leather of claim 4, wherein an outer layer is removed from the second portion.

6. A method of treating silk leather with an ionic compound, the method comprising applying an ionic surface treatment to an untreated silk leather to form an ionic-treated silk leather, wherein the ionic surface treatment comprises:
water, a cation, and optionally a carrier solvent.

7. The method of claim 6, wherein the ionic surface treatment comprises water, the carrier solvent, and the cation.

8. The method of claim 6, wherein the ionic surface treatment consists of water and the cation.

9. The method of claim 6, the method further comprising applying an alginate solution to the ionic-treated silk leather to form a polysaccharide-treated ionic-treated silk leather.

10. The method of claim 9, the method further comprising removing an outer layer formed on the polysaccharide-treated ionic-treated silk leather by the applying, wherein the removing produces exfoliated treated silk leather.

11. The ionic-treated silk leather of claim 1, wherein the carrier solvent is at least one of methanol, ethanol, propanol, isopropanol, acetone, dimethyl sulfoxide, chloroform, or acetonitrile.

12. The ionic-treated silk leather of claim 1, wherein the cation is multivalent, optionally wherein the cation is at least one of Ca²⁺, Cu²⁺, Fe²⁺, or Fe³⁺.

13. The ionic-treated silk leather of claim 1, wherein the ionic surface treatment comprises at least one of dipping, soaking, brushing, rinsing, immersing, spraying, or dripping.

14. The ionic-treated silk leather of claim 1, wherein the ionic surface treatment is applied at least one time, at least two times, or at least three times.

15. The ionic-treated silk leather of claim 1, wherein a hydrophobicity of the ionic-treated silk leather is improved relative to a comparison hydrophobicity for a comparison ionic-treated silk leather that lacks the ionic surface treatment.

16. The ionic-treated silk leather of claim 1, wherein a water resistance of the ionic-treated silk leather is improved relative to a comparison water resistance for a comparison ionic-treated silk leather that lacks the ionic surface treatment.

17. The ionic-treated silk leather of claim 1, wherein the ionic surface treatment is Ajisawa reagent.

18. (canceled)

19. A method of inducing thermal transition in a silk leather, the method comprising applying an elevated pressure for a pressure applying length of time and an elevated temperature for a temperature applying length of time to the silk leather to form a thermal transition silk leather, wherein the thermal transition silk leather has a degree of transition, wherein the silk leather comprises gelatin.

20. The method of claim 19, wherein the applying the elevated pressure and the applying the elevated temperature are simultaneous.

21. The method of claim 19, wherein the applying the elevated pressure and the applying the elevated temperature are sequential.

22.-53. (canceled)
